(19) United States
(12) Patent Application Publication
(10) Pub. No.: US 2019/0199577 A1
(43) Pub. Date: Jun. 27, 2019

(54) OSS DISPATCHER FOR POLICY-BASED CUSTOMER REQUEST MANAGEMENT

(71) Applicant: TELEFONAKTIEBOLAGET LM ERICSSON (PUBL), Stockholm (SE)

(72) Inventors: Giuseppe Burgarella, Princeton, NJ (US); Daniele Ceccarelli, Sollentuna (SE); Neha Aneja, Piscataway, NJ (US); James Daniel Alfieri, Easton, PA (US)

(21) Appl. No.: 15/850,086

(22) Filed: Dec. 21, 2017

(51) Int. Cl. H04L 12/24

(52) U.S. Cl. CPC H04L 41/044; H04L 41/024

(57) ABSTRACT

A converged Operations Support System (OSS) for managing a hierarchical network environment including a plurality of network domains. In one embodiment, each OSS component of the OSS is mapped against a particular hierarchical information layer of a plurality of hierarchical information layers required to manage the hierarchical network environment. When a query is received at a northbound interface of the OSS from an external requester, a determination is made as to which particular hierarchical information layers are required to generate a response to the query. Responsive to the determination, the query may be forwarded to one or more OSS components mapped to the particular hierarchical information layers for generating a response.

### TECHNICAL FIELD

The present disclosure generally relates to communications networks. More particularly, and not by way of any limitation, the present disclosure is directed to an Operations Support System (OSS) having a dispatcher for effectuating policy-based customer request management in a communications network.

### BACKGROUND

Operations Support Systems (OSS) encompass a set of processes, structures and components that a network operator requires to provision, monitor, control and analyze the network infrastructure, to manage and control faults, and to perform functions that involve interactions with customers, inter alia. Operations support can sometimes also include the historical term “network management”, which relates to the control and management of network elements. A Business Support System (BSS) encompasses the processes a service provider requires to conduct relationships with external stakeholders including customers, partners and suppliers. Whereas the boundary between operations support and business support is somewhat arbitrary and indistinct, business support functions may generally comprise the customer-oriented subset of operations support. For example, business support processes involving fulfillment of an order from a customer for a new service must flow into the operations support processes to configure the resources necessary to deliver the service via a suitable network environment. Support systems are therefore often described as OSS/BSS systems or simply OS/BS.

Operations and business support systems are complex, critical and expensive pieces of a service provider's functions. Much attention has been given to OSS in standards bodies with a view to achieve a degree of uniformity of approach.

Technologies such as Software Defined Networking (SDN) and Network Function Virtualization (NFV) are transforming traditional networks into software programmable domains running on simplified, lower cost hardware, driving the convergence of IT and telecom markets. This convergence is expected to overhaul network operations, enable new services and business models, and impact existing OSS/BSS solutions.

Whereas advances in technologies such as SDN, NFV, packet-optical integration, and cloud-based service hosting continue to grow apace, several lacunae remain in the field of OSS with respect to efficiently managing today's highly complex network environments, thereby requiring further innovation as will be set forth hereinbelow

### SUMMARY

The present patent disclosure is broadly directed to a converged OSS and an associated method operating therewith for managing a hierarchical network environment including a plurality of network domains using policy-based customer request dispatching. In one embodiment, each component of the OSS is mapped against a particular hierarchical information layer of a plurality of hierarchical information layers required to manage the hierarchical network environment. When a query is received at a northbound interface (NBI) of the OSS from an external requester, e.g., a business support node or a customer management node, etc., a determination is made as to which particular hierarchical information layers are required to generate a response to the query. Responsive to the determination, the query may be forwarded to one or more OSS components mapped to the particular hierarchical information layers for generating a response.

In one aspect, an embodiment of an OSS is disclosed for managing a hierarchical network environment including a plurality of network domains. The claimed OSS comprises, inter alia, one or more processors, an NBI configured to receive queries from one or more external requesters, and a plurality of OSS components each configured to manage a particular level of the hierarchical network environment, each particular level requiring a corresponding hierarchical information layer having a set of defined characteristics. A query dispatcher module is coupled to the one or more processors and having program instructions that are configured to perform following acts when executed by the one or more processors: mapping each OSS component against a particular hierarchical information layer; when a query is received at the NBI from an external requester, determining which particular hierarchical information layers are required to generate a response to the query; responsive to the determination, forwarding the query to one or more OSS components mapped to the particular hierarchical information layers; and generating a response to the external requester based on information received from the one or more OSS components responsive to the query. In one variation, the query dispatcher module may be configured to determine that the query contains an explicit indication operative to indicate the particular hierarchical information layers required to generate the response and thereby forward the query to appropriate OSS components. In another variation, the query dispatcher module may be configured to implicitly forward the incoming query to the particular hierarchical information layers based on the query's type.

In still further aspects, an embodiment of a query dispatching method and a non-transitory computer-readable medium or distributed media containing computer-executable program instructions or code portions stored thereon for performing such a method when executed by a processor entity of a OSS node, component, apparatus, system, network element, and the like, are disclosed. Further features of the various embodiments are as claimed in the dependent claims.

Example embodiments set forth herein advantageously provide scalability and improved responsiveness of a complex converged OSS platform by avoiding useless replication of huge amount of data required to manage multi-operator, multi-domain hierarchical network environments of today. Consequently, example embodiments may reduce overhead and improve efficiency in an OSS implementation. Some embodiments also have the advantage of not requiring any upgrade in the network but only in the OSS system. Some embodiments are also fully backward compatible with entities not supporting queries augmented with explicit indications or indicia of policies, as will be set forth hereinbelow. Further, the present invention provides application program interface (API) flexibility, in the sense that a single API can offer complex implementation based on the configured policies at an OSS dispatcher according to certain embodiments.

Additional benefits and advantages of the embodiments will be apparent in view of the following description and accompanying Figures.

### BRIEF DESCRIPTION OF THE DRAWINGS

Embodiments of the present disclosure are illustrated by way of example, and not by way of limitation, in the Figures of the accompanying drawings in which like references indicate similar elements. It should be noted that different references to “an” or “one” embodiment in this disclosure are not necessarily to the same embodiment, and such references may mean at least one. Further, when a particular feature, structure, or characteristic is described in connection with an embodiment, it is submitted that it is within the knowledge of one skilled in the art to effect such feature, structure, or characteristic in connection with other embodiments whether or not explicitly described.

The accompanying drawings are incorporated into and form a part of the specification to illustrate one or more exemplary embodiments of the present disclosure. Various advantages and features of the disclosure will be understood from the following Detailed Description taken in connection with the appended claims and with reference to the attached drawing Figures in which:

FIG. 1 depicts a generalized hierarchical network environment having a plurality of network domains wherein an OSS embodiment of the present invention may be practiced;

FIG. 2 depicts a block diagram of an example converged OSS according to an embodiment of the present invention;

FIGS. 3A and 3B are flowcharts illustrative of various blocks, steps and/or acts of a method operating at a converged OSS that may be (re)combined in one or more arrangements, with or without blocks, steps and/or acts of additional flowcharts of the present disclosure;

FIG. 4 depicts an example mapping mechanism for associating OSS components with respective hierarchical information layers that may be dynamically interrogated and/or manipulated for managing a multi-domain hierarchical network environment according to an embodiment;

FIGS. 5A-5C illustrate an example of dispatching of a query to different OSS components depending on which hierarchical information layers are involved in an example embodiment of the present invention;

FIGS. 6A-6C illustrate another example of dispatching of a query to different OSS components depending on which hierarchical information layers are involved in an example embodiment of the present invention;

FIG. 7A depicts another view of a converged OSS having a policy-based query dispatcher in an example embodiment of the present invention;

FIGS. 7B and 7C illustrate further illustrative views of implicit forwarding of queries in an example embodiment of the present invention;

FIGS. 7D-1 and 7D-2 illustrate further illustrative views of query dispatching based on explicit indication in an example embodiment of the present invention;

FIG. 8 depicts a network function virtualization (NFV) architecture that may be implemented in conjunction with a converged OSS of the present invention;

FIG. 9 depicts a block diagram of a computer-implemented platform or apparatus that may be (re)configured and/or (re)arranged as an OSS orchestrator or OSS component according to an embodiment of the present invention; and

FIGS. 10A/10B illustrate connectivity between network devices (NDs) of an exemplary OSS and/or associated multi-domain network, as well as three exemplary implementations of the NDs, according to some embodiments of the present invention.

### DETAILED DESCRIPTION

In the description herein for embodiments of the present invention, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention. Accordingly, it will be appreciated by one skilled in the art that the embodiments of the present disclosure may be practiced without such specific components. It should be further recognized that those of ordinary skill in the art, with the aid of the Detailed Description set forth herein and taking reference to the accompanying drawings, will be able to make and use one or more embodiments without undue experimentation.

Additionally, terms such as “coupled” and “connected,” along with their derivatives, may be used in the following description, claims, or both. It should be understood that these terms are not necessarily intended as synonyms for each other. “Coupled” may be used to indicate that two or more elements, which may or may not be in direct physical or electrical contact with each other, co-operate or interact with each other. “Connected” may be used to indicate the establishment of communication, i.e., a communicative relationship, between two or more elements that are coupled with each other. Further, in one or more example embodiments set forth herein, generally speaking, an element, component or module may be configured to perform a function if the element may be programmed for performing or otherwise structurally arranged to perform that function.

As used herein, a network element (e.g., a router, switch, bridge, etc.) is a piece of networking equipment, including hardware and software that communicatively interconnects other equipment on a network (e.g., other network elements, end stations, etc.). Some network elements may comprise “multiple services network elements” that provide support for multiple networking functions (e.g., routing, bridging, switching, Layer-2 aggregation, session border control, Quality of Service, and/or subscriber management, and the like), and/or provide support for multiple application services (e.g., data, voice, and video). Subscriber/tenant end stations (e.g., servers, workstations, laptops, netbooks, palm tops, mobile phones, smartphones, multimedia phones, Voice Over Internet Protocol (VoIP) phones, user equipment, terminals, portable media players, GPS units, gaming systems, set-top boxes) may access or consume resources/services, including cloud-centric resources/services, provided over a multi-domain, multi-operator heterogeneous network environment, including, e.g., a packet-switched wide area public network such as the Internet via suitable service provider access networks, wherein a converged OSS may be configured according to one or more embodiments set forth hereinbelow. Subscriber/tenant end stations may also access or consume resources/services provided on virtual private networks (VPNs) overlaid on (e.g., tunneled through) the Internet. Typically, subscriber/tenant end stations may be coupled (e.g., through customer/tenant premise equipment or CPE/TPE coupled to an access network (wired or wirelessly)) to edge network elements, which are coupled (e.g., through one or more core network elements) to other edge network elements, and to cloud-based data center elements with respect to consuming hosted resources/services according to service management agreements, contracts, etc.

One or more embodiments of the present patent disclosure may be implemented using different combinations of software, firmware, and/or hardware. Thus, one or more of the techniques shown in the Figures (e.g., flowcharts) may be implemented using code and data stored and executed on one or more electronic devices or nodes (e.g., a subscriber client device or end station, a network element and/or a management node, etc.). Such electronic devices may store and communicate (internally and/or with other electronic devices over a network) code and data using computer-readable media, such as non-transitory computer-readable storage media (e.g., magnetic disks, optical disks, random access memory, read-only memory, flash memory devices, phase-change memory, etc.), transitory computer-readable transmission media (e.g., electrical, optical, acoustical or other form of propagated signals—such as carrier waves, infrared signals, digital signals), etc. In addition, such network elements may typically include a set of one or more processors coupled to one or more other components, such as one or more storage devices (e.g., non-transitory machine-readable storage media) as well as storage database(s), user input/output devices (e.g., a keyboard, a touch screen, a pointing device, and/or a display), and network connections for effectuating signaling and/or bearer media transmission. The coupling of the set of processors and other components may be typically through one or more buses and bridges (also termed as bus controllers), arranged in any known (e.g., symmetric/shared multiprocessing) or heretofore unknown architectures. Thus, the storage device or component of a given electronic device or network element may be configured to store code and/or data for execution on one or more processors of that element, node or electronic device for purposes of implementing one or more techniques of the present disclosure.

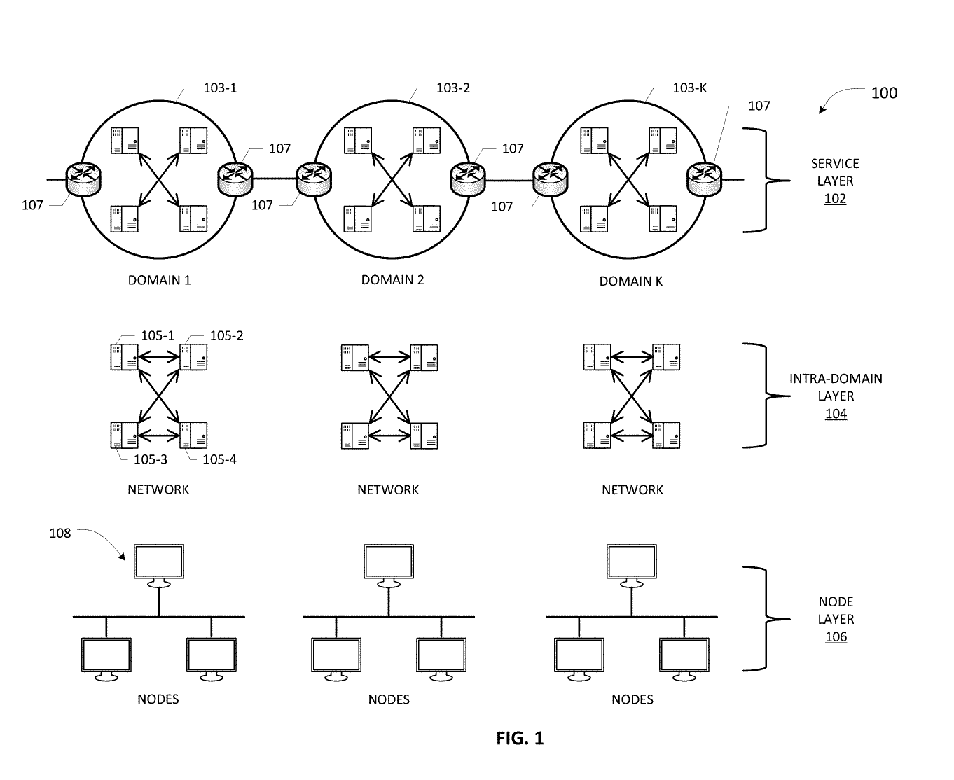

Referring now to the drawings and more particularly to FIG. 1, depicted therein is a generalized hierarchical network environment 100 having a plurality of network domains wherein an OSS embodiment of the present invention may be practiced. By way of illustration, network environment 100 may include network domains 103-1 to 103-K that may be managed, owned, operated, deployed, and/or installed by different operators, each domain potentially using various types of infrastructures, equipment, physical plants, etc., as well as potentially operating based on a variety of technologies, communications protocols, and the like, at any number of OSI levels, in order to support an array of end-to-end services, applications, and/or voice/data/video/multimedia communications in a multi-vendor, multi-provider and multi-operator environment. Further, example domains may be virtualized using technologies such as Network Function Virtualization Initiative (NFVI), and/or may involve scalable, protocol-independent transport technologies such as Multiprotocol Label Switching (MPLS) that can support a range of access technologies, including, e.g., ATM, Frame Relay, DSL, etc., as well as incorporate disparate technologies such as packet-optical integration, multi-layer Software Defined Networking (ML-SDN), Coarse/Dense Wavelength Division Multiplexing (CWDM or DWDM), Optical Transport Networking, and the like. Regardless of the rich diversity of the example network domains 103-1 to 103-K, they may be integrated or provisioned to be coupled to each other using suitable ingress nodes and egress nodes, gateways, etc., generally referred to as border nodes 107, to facilitate a host of agile services with appropriate service lifecycle management and orchestration, such as, e.g., bandwidth provisioning services, VPN provisioning services, end-to-end connectivity services comprising, inter alia, services including but not limited to Carrier Ethernet, IP VPN, Ethernet over SDH/SONET, Ethernet over MPLS, etc.

Hierarchically, an example domain may be implemented as an autonomous administrative system (AS) wherein multiple nodes within the domain are reachable to each other using known protocols under a suitable network manager or intra-domain manager entity (not shown in this FIG.). Architecturally, multiple network elements, e.g., individual L2/L3 devices such as routers, switches, bridges, etc., may be interconnected to form an example domain or AS network, wherein an individual node or element may be comprised of a number of hardware/software components, such as ports, network interface cards, power components, processor/storage components, chassis/housing components, racks, blades, etc., in addition to various application software, middleware and/or firmware components and subsystems. By way of illustration, nodes 105-1 to 105-4 are exemplified as part of example domain 103-1, wherein an example node or network element may include a plurality of components, subsystems, modules, etc., generally shown at reference numeral 108.

In accordance with the teachings of the present invention, a hierarchical model of information may be defined for managing each layer of a hierarchical network environment such as the foregoing network environment 100, as part of a converged OSS platform configured to manage and orchestrate various heterogeneous network domains, as will be set forth in further detail hereinbelow. Depending on the type and characteristics of information required for managing a particular hierarchical level of a network environment (e.g., comprising a network of networks), a number of information layers may be defined for effectuating different purposes within the network environment. Examples of informational characteristics may be configurable depending on an OSS implementation, and may comprise, e.g., granularity of information (such as low, medium or high level of detail, for instance), refresh periods, response times required for effecting necessary topological, connectivity or provisioning changes, and the like. Broadly, each information layer at a particular level of detail may be defined to be sufficiently homogenous with respect to the granularity level as well as dynamicity of the data, which may be mapped to specific OSS components as will be set forth further below. By way of illustration, a three-layer hierarchy of information may be defined as follows with respect to the multi-domain hierarchical network environment 100 shown in FIG. 1, although skilled artisans will recognize that a different number of hierarchical information layers may be configured depending on the implementation: (i) Service Layer 102—comprising low level of detail, long information refresh period, low response on changes. Typically used for service provisioning, where only the border nodes are involved; (ii) Intra-Domain Layer 104—comprising mid level of detail, medium duration of information refresh periods, mid/fast response on changes. Typically used for path computation, where only details on nodes and links are needed and refreshes/updates are managed with the pace of the applicable routing protocols' convergence time; and (iii) Node Layer 106—comprising high level of detail, short information refresh period, high response on changes. It should be appreciated that information levels at different granularities may be used, sometimes in combination, for different types of queries. For example, alarm correlation and fault monitoring that may require granular details on individual network elements' cards, ports, interfaces and other subsystems may be correlated across different hierarchical layers to address the impact on an example end-to-end service.

In one example embodiment, once the hierarchical information layers relevant to a network environment are defined, the components or subsystems of a converged OSS platform may be mapped against each layer, depending on the characteristics of the OSS components and their requirements, e.g., in terms of level of details of the information managed, refresh timers associated with the topological map of the network portion or level a particular OSS component is responsible for managing, etc. Skilled artisans will recognize that such a mapping may be effectuated at an orchestrator component of the OSS or at a separate node or subsystem associated with the OSS. Regardless of where the OSS component⇔information layer mapping is effectuated, a dispatcher module may be configured according to an embodiment of the present invention with respect to any queries received at a northbound interface (NBI) of the OSS for determining appropriate treatment required therefor. In one arrangement, the dispatcher module may be configured to interrogate a mapping relationship database for identifying suitable OSS components that have the requisite functionality to service an incoming query and apply suitable configured policies with respect to the query and, responsive thereto, forward the query to the identified OSS components accordingly. In a further arrangement, an embodiment of the dispatcher may be configured with suitable treatment policies for implicitly forwarding different types of queries to the proper information layers (and to the associated OSS components) depending on the type of incoming queries, as will be illustrated in detail further below. Accordingly, another layer of a mapping relationship between query types and hierarchical information layers may also be maintained in an example embodiment of a converged OSS platform to facilitate such implicit forwarding of incoming queries.

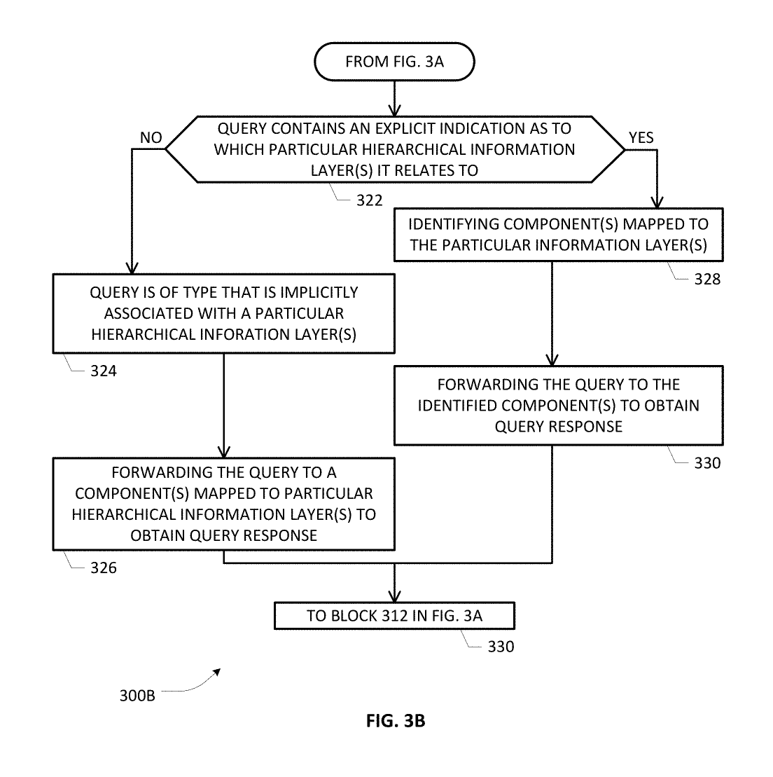

Turning to FIG. 4, depicted therein is an example mapping arrangement 400 that may be dynamically altered, manipulated and/or interrogated, which illustrates a high level mapping between OSS components 406 and corresponding hierarchical information layers 404, as well as between query types 402 and corresponding hierarchical information layers 404. A plurality of query types 408-1 to 408-N are exemplified wherein such queries may emanate from various external sources such as Business Support System (BSS) nodes, customer application coordinator nodes, customer management nodes, etc., with respect to one or more existing services or applications and/or instantiating new services or applications in a multi-domain/cross-domain network environment. Appropriate policies may be configured to provide a relationship between queries 408-1 to 408-N and one or more information layers defined for the network environment such that there is no need to specify or augment the query structure itself as to which information layers are needed for responding to the query (i.e., implicit forwarding). Further, depending on the type, a query may require information from more than one information layer in some cases. Accordingly, such queries may be implicitly mapped against a plurality of information layers that are implicated. By way of illustration, Query Type 1 408-1 may be mapped against Information Layer-p as well as any other layers relative to that layer which may be required in order to generate a complete response to the query, as indicated by reference numeral 410-1. Likewise, Query Type N 408-N may be mapped against Information Layer-r as well as other layers relative to that layer, as indicated by reference numeral 410-N.

As previously noted, each OSS component is mapped against a corresponding information layer, wherein an OSS component is configured with one or more layer-specific databases that contain information relevant to handling all aspects of management appropriate to the corresponding network hierarchy. For example, if a component is mapped to a service layer, that component may be configured with a database information relating to available domains, domain adjacencies, cross-border reachability, domain capacity/status, indicators such as Universal Unique IDs (UUIDs) or Global Unique IDs (GUIDs) of the domains, etc. Likewise, if a component is mapped to an intra-node layer, a database containing port IDs, chassis names/IDs, VLAN names, IP management addresses, system capabilities such as routing, switching, etc., as well as MAC/PHY information, link aggregation, and the like. At an intermediate granularity of information, a component mapped to an intra-domain layer may be configured with a database in similar fashion. By way of illustration, Component-a and other components mapped to Layer-p and corresponding layers are collectively shown at reference numeral 412-1. Likewise, reference numeral 412-2 refers to Component-b and other components mapped to Layer-q and corresponding layers 410-2 and reference numeral 412-N refers to Component-c and other components mapped to Layer-r and corresponding layers 410-N in the illustrative mapping arrangement 400 of FIG. 4.

One skilled in the art will recognize that the foregoing mapping relationships are not necessarily static or fixed in a “deterministic” way. In an example arrangement, which layers (and associated OSS components) are interrogated may depend on the queries as well as any information retrieved from the domain manager(s) during an interrogation process. For example, if a policy or query requires that data from a lower layer is needed, after interrogating a domain manager, the query API may then be propagated to a specific lower layer identified by the domain manager's query response. As will be set forth below in reference to various example query dispatch scenarios, components at different layers may be involved and interrogated depending on the interim responses from higher/other layers. Further, some queries may not involve interrogation of a higher level layer. Rather, they may be directly forwarded to a specific layer component based in the parameters of the query. For instance, if the query is like “Get info about the object ID=1 of network 1”, the dispatcher just sends this request to the related manager (in this example to the network manager 1, by skipping the higher level orchestrator because it is not managing the specific network).

Skilled artisans will further appreciate that as there is no need to specify any additional or extra information or indication in an implicitly mapped query, such an arrangement has the advantage of being backward compatible with legacy queries received via existing NBI communication protocols. However, it should be appreciated that this scheme may be limited due to coarse granularity of query treatment in the sense that an operator-configured query forwarding policy may only support a gross level forwarding logic (e.g., policies applying to a class or group of queries rather than at an individual query level).

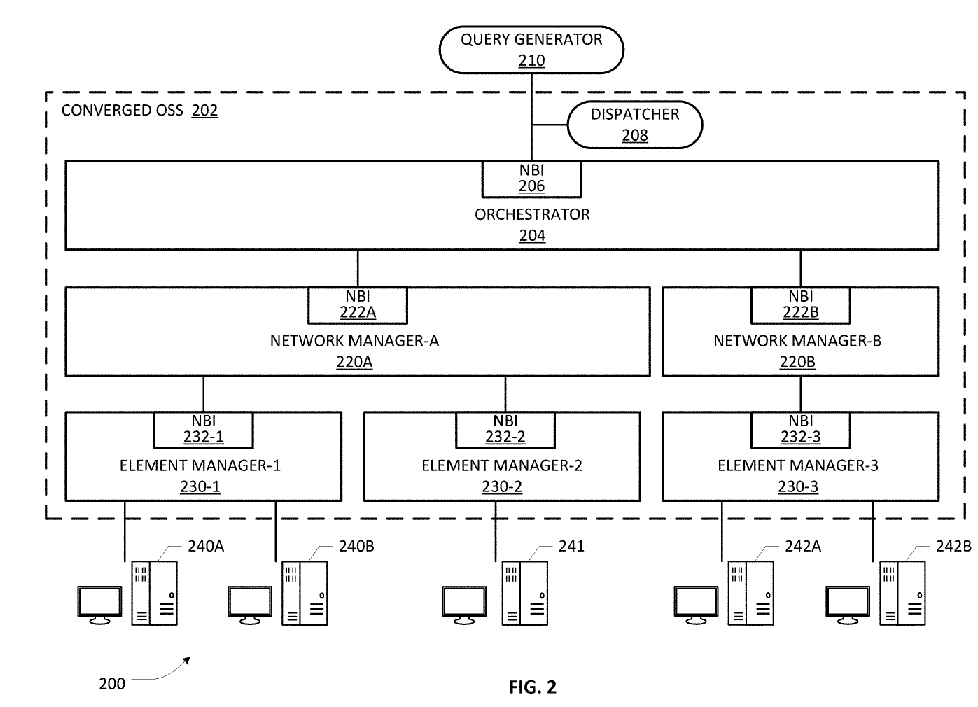

FIG. 2 depicts a multi-domain network environment 200 wherein an example converged OSS 202 may be implemented according to an embodiment of the present invention. A plurality of network elements disposed in different domains may be managed by corresponding OSS components or subsystems configured as element managers (EM), wherein each element manager is operative to model each equipment under its control based on its configuration model and abstract the equipment's inventory to the element manager's own NBI. As illustrated, equipment 240A and 240B are managed by EM-1 230-1 as its element domain, equipment 241 is managed by EM-2 230-2 as its element domain, and equipment 242A and 242B are managed by EM-3 230-3 as its element domain. Accordingly, EM-1 232-1 is configured with NBI 232-1 that provides an interface to a next higher level for abstracting the inventory of both pieces of equipment 240A and 240B. Likewise, EM-2 232-2 is provided with NBI 232-2 that abstracts the inventory of the single piece of equipment 241 and EM-3 232-3 is provided with NBI 232-3 that abstracts the inventory of both pieces of equipment 242A and 242B. At the next higher level, a plurality of network domain managers (NM) are provided that each manage all of the network domain's EM domains via the exposed EM NBIs, and model each EM domain's inventory and abstract that information to NM's NBI. By way of illustration, NM-A 220A is configured to manage EM-1 230-1 and EM-2 230-2, and therefore models each managed EM domain by abstracting respective EM domain's inventory to its NBI 222A. On the other hand, NM-B 220B is configured to manage only one EM domain, i.e., EM-3 230-3, and models it by abstracting its inventory relating to equipment nodes 240A and 240B to NM's NBI 222B. An orchestrator node or component 204 models each NM and abstracts the managed network domains (each containing one or more element domains) to its NBI 206 that is operative to interface with one or more external nodes 210 such as customer management nodes, BSS nodes, network management system (NMS) nodes, etc. In one example implementation consistent with Metro Ethernet Forum (MEF) Service Operations Specification MEF 55 that relates to Lifecycle Service Orchestration (LSO: Reference Architecture and Framework), external nodes that can generate queries to the converged OSS 202 may include customer application coordinator entities that are responsible for coordinating the management of the various service needs (e.g., compute, storage, network resources, etc.) of specific applications, wherein a customer application coordinator node may interact with OSS 202 to request, modify, manage, control, and terminate one or more products or services. In similar fashion, a business application node may generate queries to OSS 202 with respect to all aspects of business management layer functionality, e.g., product/service cataloging, ordering, billing, relationship management, service assurance, service fulfillment and provisioning, customer care, etc. It should be appreciated that, broadly, any request, interrogation, message, or query received via NBI 206 from an external requester node 210 that requires a response to be generated by OSS 202 (which itself may be formulated based on responses by one or more individual components of OSS 202) may be treated as a query for purposes of the present invention.

Still continuing with an example implementation involving the MEF 55 specification, orchestrator 204 may be configured to support an agile service framework to streamline and automate service lifecycles in a sustainable fashion for coordinated management with respect to design, fulfillment, control, testing, problem management, quality management, usage measurements, security management, analytics, and policy-based management capabilities, e.g., relative to providing coordinated end-to-end management and control of Layer 2 (L2) and Layer 3 (L3) connectivity services. Likewise, various network managers (NM-A 220A and 220B) may be configured to provide domain specific network and topology view resource management capabilities including configuration, control and supervision of the domain-level network infrastructure. In general, NMs are responsible for providing coordinated management across the network resources within a specific management and control domain. For example, an NM operative to support infrastructure control and management (ICM) capabilities within its domain can provide connection management across a specific subnetwork domain within its network domain, wherein such capabilities may be supported by subcomponents such as subnetwork managers, SDN controllers, etc. As an Open Network Foundation (ONF) Software Defined Network (SDN) controller, an NM may include the functionality for translating the network requirements from the SDN application layer down to the SDN datapaths and providing the SDN applications with an abstract view of the network including statistics, notifications and events.

Operating in concert, the various components of OSS 202 may be configured to perform the following functions at different hierarchical levels of the multi-domain environment 200: (i) Fault Management—i.e., Reading and reporting of faults in a network; for example link failure or node failure; (ii) Configuration Management—Relates to loading/changing configuration on network elements and configuring services in network; (iii) Account Management—Relates to collection of usage statistics for the purpose of billing; (iv) Performance Management—Relates to reading performance related statistics, for example reading utilization, error rates, packet loss, and latency; (v) Security Management—Relates to controlling access to assets of network, including includes authentication, encryption and password management; collectively referred to as FCAPS.

Continuing to refer to FIG. 2, a request/query dispatcher 208 may be provided as a separate functionality of OSS 202 or integrated with orchestrator 204, which receives all external queries directed to OSS's NBI, i.e., NBI 206, and administers policy-based dispatch management for forwarding the received queries to different OSS components mapped to different information layers via specific software interfaces or APIs. As previously noted, request/query dispatcher 208 may be configured with the functionality to implicitly forward queries based of query type. In an additional or alternative arrangement, suitable extensions to a protocol operating with NBI 206 may be provided that can support queries configured to explicitly carry indicators, identifiers, flags, headers, fields, or other indicia or information that are operable to specify particular policies to be applied with respect to the query (e.g., indicating which hierarchical information layers are involved). For purposes of the present application, such an arrangement where explicit indicia are provided within a query that can trigger appropriate forwarding policies within the OSS may be termed “explicit forwarding”. Accordingly, whereas in the case of implicit policy forwarding, the NBI API name itself may be operative to trigger a specific policy configured in the request/query dispatcher 208, the NBI APIs may be augmented to carry the specific information about which policy (or policies) to be applied in an embodiment involving explicit forwarding. Regardless of whether implicit policy or explicit policy scheme is used, an embodiment of the present invention involves triggering a particular policy that is responsible for mapping the request/query from the NBI and forward it to appropriate layer(s), wherein the request/query dispatcher 208 may execute an implementation-specific logic to decide the proper mapping. Skilled artisans will recognize that such dynamic mapping/dispatching logic may also include one or more of the query/request parameters in deciding where to send the query in some example embodiments.

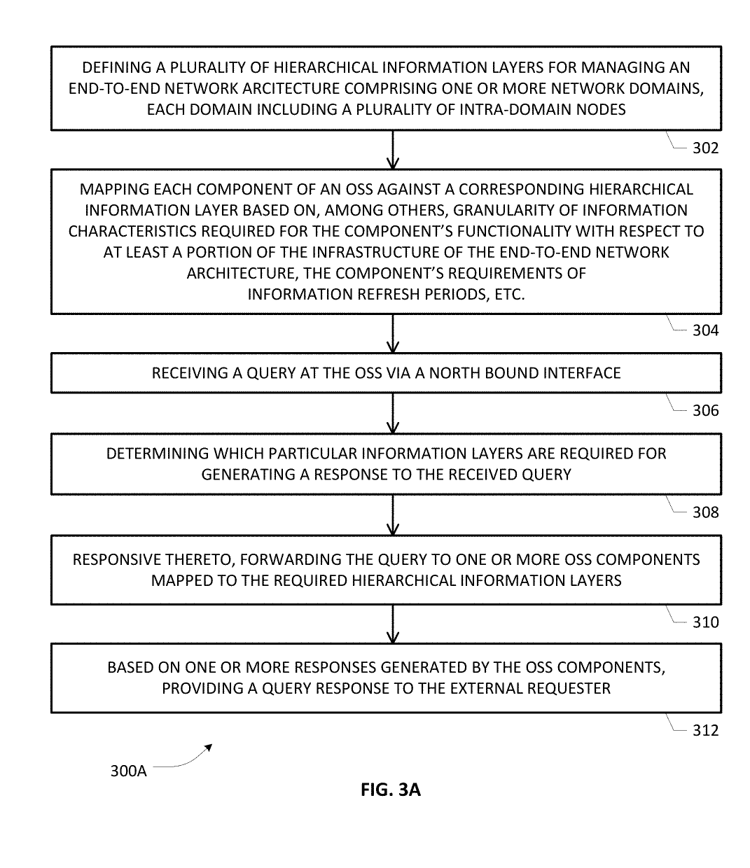

FIGS. 3A and 3B are flowcharts illustrative of various blocks, steps and/or acts of a method operating at a converged OSS that may be (re)combined in one or more arrangements, with or without blocks, steps and/or acts of additional flowcharts of the present disclosure. Process 300A set forth in FIG. 3A exemplifies an overall query dispatching scheme of a converged OSS of the present invention. At block 302, a plurality of hierarchical information layers may be defined based on a suitable hierarchy of information model for managing an end-to-end network architecture comprising one or more network domains, each domain including a plurality of intra-domain nodes. At block 304, each component of the OSS is mapped against a corresponding hierarchical information layer based on, among others, granularity of information characteristics required for the component's functionality with respect to at least a portion of the infrastructure of the end-to-end network architecture, the component's requirements of information refresh periods, etc., as previously set forth. At block 306, a query is received at the OSS via its NBI from an external node/requester. At block 308, a determination may be made which particular information layers are required for generating a response to the received query. Responsive thereto, the query may be forwarded to one or more OSS components mapped to the required hierarchical information layers (block 310). Based on one or more responses generated by the OSS components, a query response maybe provided to the external requester (block 312). Process 300B of FIG. 3B is an example flow for determining and forwarding a query based on whether implicit or explicit policy is triggered, e.g., as part of block 308. At block 322, a determination may be made whether the query contains an explicit indication as to which particular hierarchical information layer it relates to. If so, one or more OSS components mapped to the hierarchical layers identified by the policy are determined (block 328) and the query is forwarded accordingly to obtain a query response (block 330). If it is determined that the query is of a type that is implicitly associated with a particular hierarchical information layer(s) (block 324), the query may be forwarded to one or more OSS components that are mapped to the implicitly associated hierarchical information layer(s) for obtaining a query response (block 326), whereupon the process flow may return to block 312 as set forth in FIG. 3A.

Several example queries involving various forwarding scenarios will now be set forth immediately below by way of illustration for purposes of one or more embodiments of the present invention.

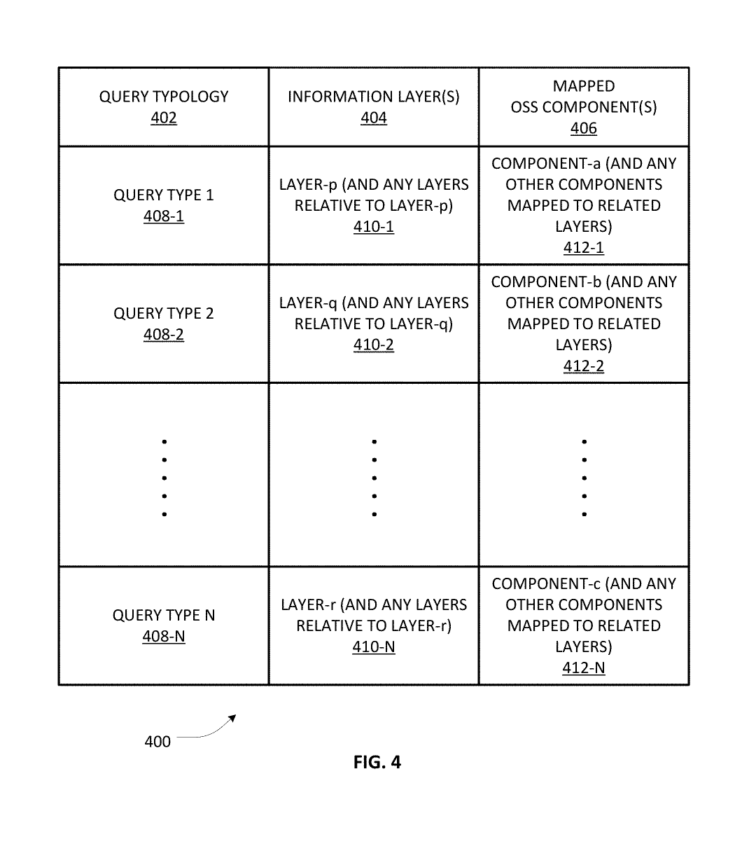

FIGS. 5A-5C illustrate an example of dispatching of a customer query/request to obtain the status of an E2E service crossing multiple domains managed by different managers, wherein different OSS components may be triggered depending on which hierarchical information layers are involved in accordance with an example embodiment of the present invention. A converged OSS platform operating in concert with a request/query dispatcher 502 is provided in scenarios 500A, 500B and 500C of FIGS. 5A-5C, respectively, similar to the converged OSS platform 202 of FIG. 2 described in detail hereinabove. Accordingly, one skilled in the art should appreciate that the description of OSS 202 is equally applicable to the OSS arrangement depicted in FIGS. 5A-5C, mutatis mutandis, taking note that request/query dispatcher 502 may be integrated with orchestrator 550 in additional/alternative embodiments. As before, EM nodes 556, 558 and 560 abstract the equipment inventory of respective EM domains via their NBIs to network managers 552 and 554, which in turn expose their NBIs to orchestrator 550. If a received query 504 is for obtaining only a high level of detail that may be based on the information maintained by orchestrator 550, request/query dispatcher 502 forwards the query to orchestrator 550 only, as indicated by a forwarding path 506 in the scenario 500A. Whereas orchestrator 550 can return the required response containing, e.g., the network status details at the level of network domains managed by NM 552 (e.g., Net 1) and NM 554 (e.g., Net 3) with a fast response period, it should be appreciated that the level of detail is rather minimal since the components at lower hierarchical information layers (i.e., having more granular information) are not interrogated. With respect to the scenario 500B, query 520 is for obtaining medium level of details relating to individual network domains of the multi-domain environment. Accordingly, request/query dispatcher 502 forwards the query to orchestrator 550 as well as NM 552 and NM 554, as illustrated by forwarding paths 522 and 524. In an example implementation, request/query dispatcher 502 may be configured to send a first request (e.g., via path 522) to orchestrator 550, which may generate a response to the effect that “E2E service is using Network 1 and Network 3”. Upon receiving such a response from orchestrator 550, request/query dispatcher 502 may then send a second request (e.g., via path 524) to NMs 552 and 554, which then report back with corresponding responses having the additional granularity of information. A full query response generated by request/query dispatcher 502 will therefore comprise information returned from NMs 552 and 554 relating to their respective network domains (e.g., Net 1 including the status of Subnet 1 and Subnet 2, Net 3 including the status of Subnet 3). An external query such as query 520 requiring a detailed response may therefore elicit a cascading set of request/response interactions between request/query dispatcher 502 and additional OSS components, thereby requiring additional response time (i.e., slower response turnaround) because of the additional OSS components (lower level) being interrogated. In a still further scenario 550C exemplified in FIG. 5C, query 530 is received for obtaining low level of details (i.e., highly granular information) relating to individual network elements or equipment of various EM domains that make up the network domains of the multi-domain environment. Accordingly, request/query dispatcher 502 forwards the query to orchestrator 550, NM 552 and NM 554, as well as EM nodes 556, 558, 560, as illustrated by forwarding paths 532, 534, 536, respectively. Similar to the example implementation set forth above, request/query dispatcher 502 may be configured to send a cascading series of requests, e.g., first, second and third requests to the required OSS component, and based on the responses received therefrom, construct a full query response that includes highest level of granularity of information relating to the individual network elements. Clearly, such most detailed responses can give rise to slowest response turnaround times as OSS components at each level are interrogated.

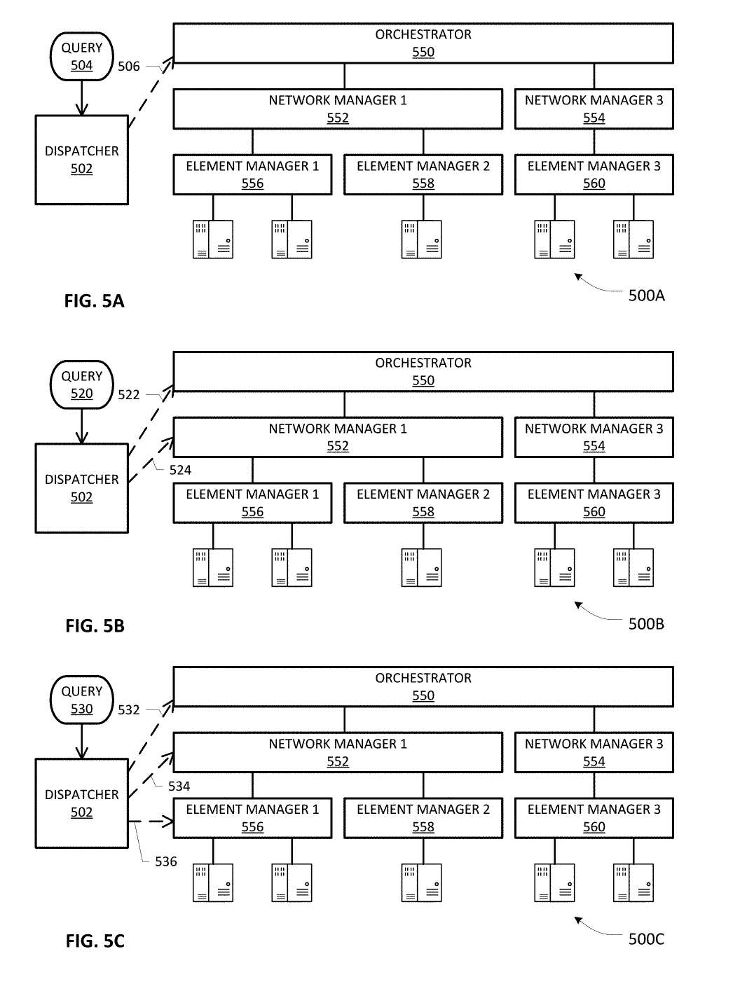

FIGS. 6A-6C illustrate another example of dispatching of a query indicating an explicit policy that requires path computation in a multi-domain network environment wherein different OSS components are mapped to different hierarchical information according to an example embodiment of the present invention. By way of illustration, three components, Component X 610, Component Y 612 and Component Z 614, are exemplified as part of an converged OSS that is configured to interoperate with a request/query dispatcher 602 for handling incoming external queries, which may require different levels of granularity of information as set forth in scenarios 600A, 600B and 600B of FIGS. 6A-6C, respectively. In scenario 600A, a query 604 may comprise an explicit path computation request such as, e.g., “Get Optimum Path {at High network level}” for determining a network path between two endpoints disposed in the multi-domain network environment. As Component X 610 comprising an informational database having high level network topology information is mapped to a high level information layer, query/request dispatcher 602 forwards the query 604 to Component X 610 via request path 606. In response, a path computation reply message may be generated including the endpoints' connectivity information spanning the two network domains, e.g., Net 1 and Net 3, if the endpoints are disposed in two separate network domains. If the endpoints are both disposed in one network domain only, a high level path computation reply message may include only that domain information. Likewise, a query 616 comprising an explicit path computation request such as, e.g., “Get Optimum Path {at Medium network level}” may be forwarded to Component X 610 with respect to first obtaining a high level topology path computation and then to Component Y 612 with respect to obtaining specific domain level topology information, as exemplified by request paths 618, 620, respectively, in scenario 600B. Depending on the high level topology information, the query response may include medium network level information relating to any combination or sub-combination of the various subnets that may be involved, e.g., Subnets 1 and 2 within Net 1 and Subnet 3 in Net 3 in accordance with the multi-domain network architectures illustrated above. In similar fashion, a query 630 comprising an explicit path computation request such as, e.g., “Get Optimum Path {at Low network level}” may be forwarded to Component X 610 with respect to first obtaining a high level topology path computation and then to Component Y 612 with respect to obtaining specific domain level topology information, followed by a request to Component Z 614 having individual network element level information (e.g., specific port IDs, etc.), as exemplified by request paths 632, 634, 636, respectively, in scenario 600C shown in FIG. 600C. As before, depending on the topology information, the query response may include highest granularity network element level information relating to any of the various pieces of network elements disposed in any combination or sub-combination of the various subnets that may be involved, e.g., Subnets 1 and 2 within Net 1 and Subnet 3 in Net 3 in accordance with the multi-domain network architectures set forth above.

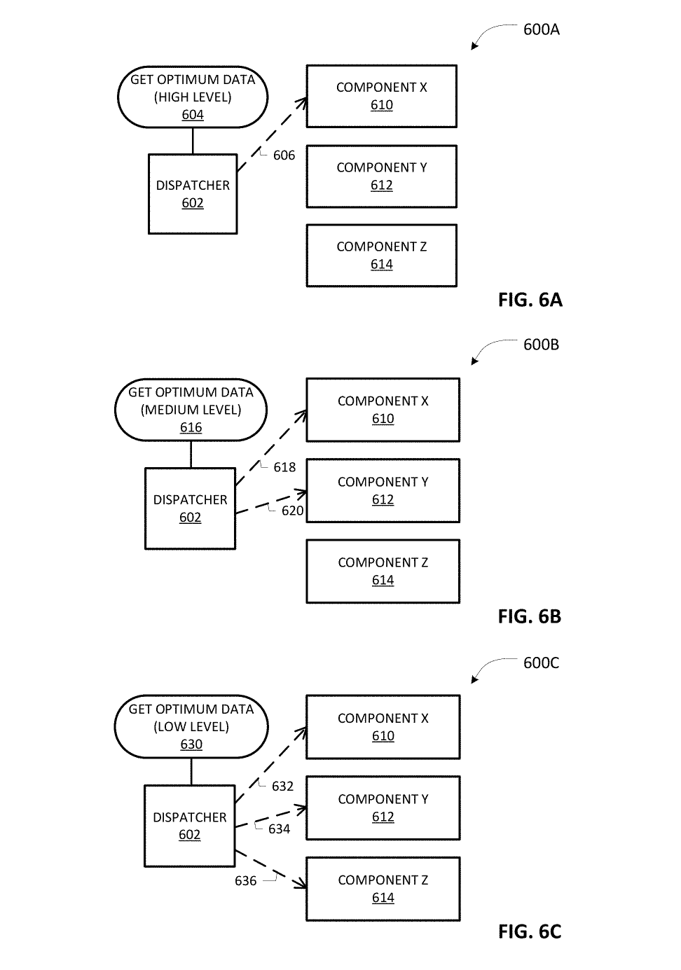

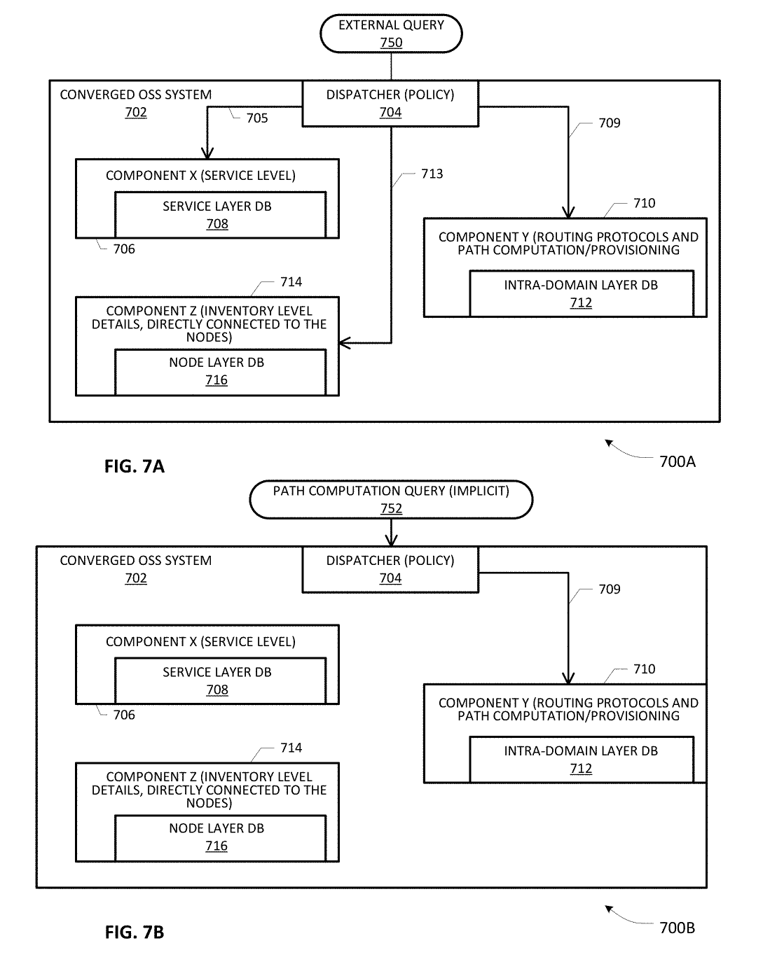

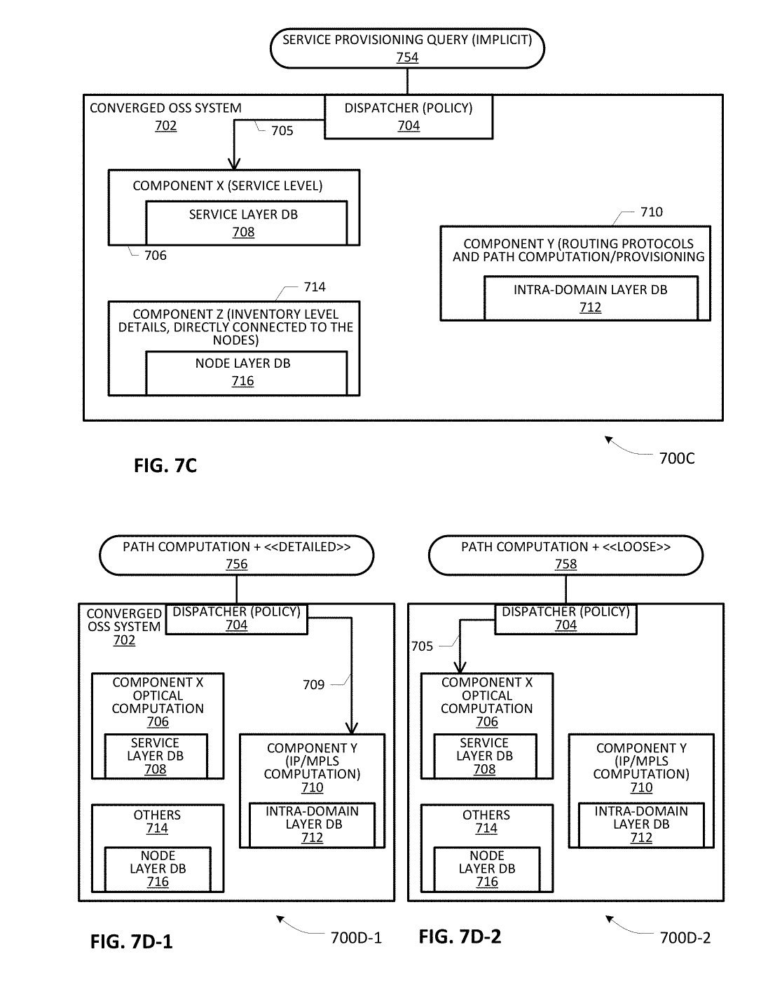

FIG. 7A depicts another view of a converged OSS having a policy-based query dispatcher according to an example embodiment of the present invention. A block diagrammatic view 700A illustrates a converged OSS platform 702 having a policy-based query dispatcher 704 integrated therewith, preferably operative in association with OSS NBI (not specifically shown). A plurality of OSS components are exemplified as part of the example converged OSS 702 shown in this FIG., similar to the embodiments described hereinabove. By way of illustration, an OSS Component X 706 is configured to be in charge of provisioning and managing services, which is mapped against a service layer. Accordingly, a service layer database 708 may be provisioned with Component X 706. In similar fashion, a Component Y 710 in charge of computing paths and provisioning tunnels, which maps against an intra-domain layer and a Component Z 714 in charge of managing the inventory of the network elements and nodes (and hence having a direct connectivity to them) are illustrated as part of OSS 702. Based on the hierarchical information layer mapping, Component Y 710 and Component Z 714 may be provisioned with appropriate databases 712, 716, respectively, having layer-specific information, as previously set forth in detail hereinabove. By way of further example, various routing protocols and related databases may be provided as part of the database 712 associated with Component Y 710, including but not limited to IP/MPLS, Equal Cost Multi Path (ECMP) protocols, Intermediate System-to-Intermediate System (IS-IS) routing protocol, link-state protocols such as Open Shortest Path First (OSPF) routing protocol, distance-vector routing protocols, various flavors of Interior Gateway Protocol (IGP) that may be used for routing information within a domain or autonomous system (AS), etc., along with databases such as forwarding information bases (FIBs) and routing information bases (RIBs), and the like. Additionally, since an Exterior Gateway Protocol (EGP) may be used for determining network reachability between autonomous systems and makes use of IGPs to resolve routes within an AS, related information may also be provided.

As set forth previously, the dispatcher logic executing at query dispatcher 704 is operative to execute forwarding decisions based on configured policies, either with implicit or explicit policy mechanisms, to applicable OSS components via suitable communication paths 705, 709, 713, which may be internal API calls within the converged OSS platform 702. Skilled artisans will recognize that various mechanisms for effectuating communications between query dispatcher 704 and OSS components may be implemented depending on how and where the dispatcher logic is configured in an example OSS arrangement with respect to a multi-domain network environment.

FIGS. 7B and 7C illustrate further example views of implicit forwarding of queries according to an embodiment of the present invention. An implicit path computation query 752 is shown in an arrangement 700B, which is received, intercepted, or otherwise obtained by query dispatcher 704. The received query 752 has an implicit mapping against the information level layer required for resolving the query. Query dispatcher 704 is accordingly configured to forward query 752 to Component Y 710 mapped to an intra-domain layer. Examples of policies in this illustrative scenario may include (i) mapping between the type of request and the layer/component to which to forward the request; and (ii) conditional mapping like, e.g., request is for path computation details if the domain pertaining to the query is of a particular type, e.g., MPLS. Both types of mapping mechanisms may be provided as part of a mapping database such as the database 400 described hereinabove. Responsive to executing the dispatcher logic, query 752 may be forwarded to Component Y 710 via communication path 709. Yet another implicit query 754 may involve a service provisioning query, which may be forwarded to Component X 706 via communication path 705 upon determining that the received service provisioning query 754 is of the type requiring information at a service layer to which Component X 706 is mapped, as exemplified in the arrangement 700C shown in FIG. 7C.

FIGS. 7D-1 and 7D-2 illustrate further example views of query dispatching based on explicit indication according to an example embodiment of the present invention. As described previously, explicit forwarding may be based on the augmentation of a query with explicit indicia or indication of the type of treatment that is requested against a policy. In other words, policies are not configured on the dispatcher but may be indicated in the query itself by way of suitable indicators, parametric data fields, or other indicia. For example, an OSS platform configured to interoperate with a packet-optical integration network environment may receive a path computation query where it is requested to perform detailed path computations at the IP/MPLS layer with a number of complex constraints, while the requirement against the optical network is only to provide connectivity between the routers without the need for a detailed path computation and provisioning, i.e., path computation details at higher granularity of detailed information or at less granularity of information similar to the embodiments as set forth in FIGS. 6A-6C described above. In the arrangement 700D-1 of FIG. 7D-1, a query 756 that explicitly indicates a higher granularity of path computation details is received by query dispatcher 704, which in the scenario of packet+optical network environment is configured to be able to distinguish between the levels of detail required in resolving the query and hence the appropriate information layer to forward the query to. For instance, a path computation request with policy set to “Detailed” or “Medium Level” may be forwarded to the component mapped to the intra-domain layer, i.e., Component Y 710 via communication path 709, for an accurate IP/MPLS path computation using a database populated by the relevant routing protocols. On the other hand, a query 758 that explicitly indicates a lower granularity of path computation details (e.g., explicit policy indication set to “Loose” or “High”) is received by query dispatcher 702, as shown in the arrangement 700D-2 of FIG. 7D-2. In the illustrative scenario of a packet+optical network environment, such a query would be forwarded to the component in the service layer, where a pure reachability assessment among optical nodes would be performed, e.g., by Component X 706. In another arrangement, an optical path request may be dependent on each other, e.g., where it can be assumed that the optical connectivity is fully meshed and a request can comprise multi-level query. By way of illustration, the query may involve requesting/retrieving an optimal packet path (step 1) and, depending on the required connectivity between the packet nodes, determining/obtaining the best paths between the involved nodes (step 2).

Yet another illustrative query dispatching scenario involves service quality assurance and alarm correlation in a multi-domain hierarchical network environment where poor service quality is reported by a customer. The end-to-end customer service may pass through multiple domains, each of which contain multiple networks that in turn have many nodes, each of which have many components, as previously highlighted. The reported problem can be caused by a fault/alarm with any component in any node, network or domain. Assuming a network environment where the service traverses three domains, each containing four nodes, each node containing N components, a traditional assurance system will query each domain, then each network in each domain, and then each node in each network in order to identify the failed/alarmed component, thereby resulting in 3 domain queries, 12 node queries and N*12 component queries, with a total of (3+4*3+N*12)=(15+N*12) queries. Any traditional approach to optimize this depends on requiring the assurance system to have a priori knowledge of the network topology.

Instead of a traditional assurance system issuing a large number of queries across domains, networks and nodes to build the topology and determine the root cause, an embodiment of the present invention allows a single request to the OSS dispatcher, which leverages the network topology information that it maintains as orchestrator to identify the affected domains, networks, nodes, and components for the service. Responsive to the assurance query, the dispatcher logic directs requests to domain, network and node controllers as needed to gather information as follows: 3 domain queries resulting in identifying just one alarmed network domain, which leads to four nodes (just for the alarmed network, resulting in identifying just one alarmed node, which leads to N queries (just for the alarmed node). Therefore, only a total of (3+4+N) queries=(7+N) queries are needed in an embodiment of the present invention for reporting a consolidated view back to the service assurance system, thereby advantageously reducing the number of queries required. Where a huge number of components, network elements, subnets and network domains are coupled together for end-to-end service provisioning, such a reduction in messaging can be significant, leading to better conservation of compute and bandwidth resources in an OSS platform.

Moreover, it should be appreciated that in an embodiment of the present invention the dispatcher functionality may be configured to forward an external query to one or more specific hierarchical information layers depending on the type and content of the external query. For instance, if the query is like “Get Info about Object ID=1 of Network 1”, the dispatcher just sends the request to the network domain level OSS component, i.e., NM 1 in this example, by skipping the orchestrator because it is not managing the specific network and no separate a priori request to the orchestrator is needed to obtain the network manager's ID since it is already identified in the external query. In other words, no cascading set of request/response interactions are needed when queries contain specific IDs or indicia associated with the hierarchical information layers required for generating appropriate responses.

One skilled in the art will recognize that a number of standard interfaces and protocols may be used, extended or otherwise modified to support requests to a converged OSS platform of the present invention, wherein a query dispatcher embodiment according to the teachings herein may be advantageously used for managing an integrated multi-domain/multi-operator network environment. Without limitation, example interface/protocol embodiments will now be set forth immediately below with which a converged OSS platform of the present invention may be configured to interoperate in a particular arrangement.

In one embodiment, path computation requests may be issued using the IETF specification “Path Computation Element (PCE) Communication Protocol (PCEP)”, RFC 5440, incorporated by reference herein, which sets forth an architecture and protocol for the computation of MPLS and Generalized MPLS (GMPLS) Traffic Engineering Label Switched Paths (TE LSPs). The PCEP protocol is a binary protocol based on object formats that include one or more Type-Length-Value (TLV) encoded data sets. A Path Computation Request message (also referred to as a PCReq message) is a PCEP message sent by a Path Computation Client (PCC) to a Path Computation Element (PCE) to request a path computation, which may carry more than one path computation request. In one example embodiment of the present invention, a TLV may be added to the PCReq message for carrying an explicit policy to be used when forwarding the path computation request. As described in detail above, such a modification may be further refined to specify what level of granularity of path computation details is required (e.g., High level (meaning fewer details), Low level (meaning more details), and the like).

Another embodiment of the present invention may involve certain data modeling languages used for configuring network state data, such as, e.g., YANG data modeling language, which is a modeling language used to model configuration and state data manipulated by the Network Configuration Protocol (NETCONF) and related RESTCONF (which is a Representational State Transfer or REST like protocol running over HTTP for accessing data defined in YANG using datastores defined in NETCONF). YANG, NETCONF and RESCONF are specified in a number of standards, e.g., IETF RFC 6020, IETF RFC 6241, draft-bierman-netconf-restconf-02 IETF 88, which are incorporated by reference herein. As such, NETCONF is designed to be a network management protocol wherein mechanisms to install, manipulate, and delete configuration of network devices are provided, whose operations may be realized via NETCONF remote procedure calls (RPCs) and NETCONF notifications. The syntax and semantics of the YANG modeling language and the data model definitions therein are represented in the Extensible Markup Language (XML), which are used by NETCONF operations to manipulate data. In accordance with the teachings of the present patent application, YANG models may be augmented either in a proprietary or industry-standard manner for purposes on an example embodiment. Using an alarm retrieval query by way of illustration, a customer request may be augmented with the specification of an alarmed resource to be analyzed as the following multi-level construct, e.g., (i) Service; (ii) Path; (iii) Node; (iv) Card; and (v) Interface, where a combination or sub-combination of levels may be specified depending on the granularity of information needed. Based on the specified policy, a query/request dispatcher of the present invention may be configured to forward the request to different layers in the OSS.

Yet another embodiment of the present invention may involve an implementation complying with the MEF 55 specification, referenced herein above, wherein a management interface reference point known as LEGATO is provided between a Business Application layer and a Service Orchestration Functionality (SOF) layer to allow management and operations interactions supporting LSO connectivity services. This interface uses an end-to-end view across one or more operator domains from the perspective of the LSO Orchestrator. In accordance with the teachings of the present patent application, embodiments of the invention can be used advantageously with respect to queries such as, e.g., (a) Business Applications requesting service feasibility determination; (b) Business Applications requesting reservation of resources related to a potential Service and/or Service Components; (c) Business Applications requesting activation of Service and/or Service Components; (d) Business Applications receiving service activation tracking status updates; and (e) Configuration of Service Specifications in the Service Orchestration Functionality, etc. Considering type (a) requests as an example, an embodiment of the present invention may be configured wherein it is specified whether the feasibility determination needs to be executed considering just reachability constraints (i.e., a high level of details) or e.g., traffic engineering constraints (i.e., at a more detailed level), which may be forwarded to different OSS components as set forth previously.

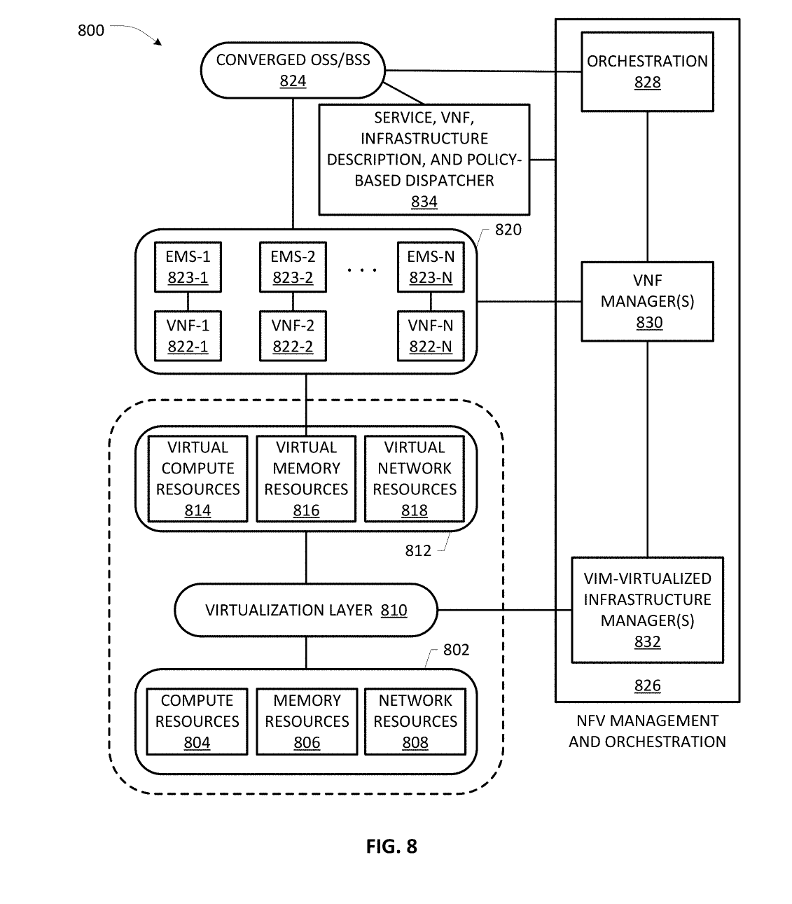

Turning to FIG. 8, depicted therein is a network function virtualization (NFV) architecture 800 that may be applied in conjunction with a converged OSS of the present invention configured to manage a multi-operator, multi-domain heterogeneous network environment such as the environment 100 set forth in FIG. 1. Various physical resources and services executing thereon within the multiple domains (i.e., network domains, EM domains, nets/subnets, etc.) of the network environment 100 may be provided as virtual appliances wherein the resources and service functions are virtualized into suitable virtual network functions (VNFs) via a virtualization layer 810. Resources 802 comprising compute resources 804, memory resources 806, and network infrastructure resources 808 are virtualized into corresponding virtual resources 812 wherein virtual compute resources 814, virtual memory resources 816 and virtual network resources 818 are collectively operative to support a VNF layer 820 including a plurality of VNFs 822-1 to 822-N, which may be managed by respective element management systems (EMS) 823-1 to 823-N. Virtualization layer 810 (also sometimes referred to as virtual machine monitor (VMM) or “hypervisor”) together with the physical resources 802 and virtual resources 812 may be referred to as NFV infrastructure (NFVI) of a network environment. Overall NFV management and orchestration functionality 826 may be supported by one or more virtualized infrastructure managers (VIMs) 832, one or more VNF managers 830 and an orchestrator 828, wherein VIM 832 and VNF managers 830 are interfaced with NFVI layer and VNF layer, respectively. A converged OSS platform 824 (which may be integrated or co-located with a BSS in some arrangements) is responsible for network-level functionalities such as network management, fault management, configuration management, service management, and subscriber management, etc., as noted previously. In one arrangement, various OSS components of the OSS platform 824 may interface with VNF layer 820 and NFV orchestration 828 via suitable interfaces. In addition, OSS/BSS 824 may be interfaced with a configuration module 834 for facilitating service, VNF and infrastructure description input, as well as policy-based query dispatching. Broadly, NFV orchestration 828 involves generating, maintaining and tearing down of network services or service functions supported by corresponding VNFs, including creating end-to-end services over multiple VNFs in a network environment, (e.g., service chaining for various data flows from ingress nodes to egress nodes). Further, NFV orchestrator 828 is also responsible for global resource management of NFVI resources, e.g., managing compute, storage and networking resources among multiple VIMs in the network.

Based on the foregoing, it should be appreciated that in the context of the present application, the dispatcher functionality of a converged OSS platform such as OSS 824 may also be configured to forward NBI queries to suitable OSS components that may be mapped to different hierarchical information layers based on how the virtualized resources are organized in accordance with NFVI. It should be appreciated that because the physical resources allocated to a VNF are considered to be elastic and the VNFs can run on multiple physical infrastructure network nodes, there is a loose coupling between the VNFs and the physical infrastructure hardware nodes they exist on, which allows greater scalability and dynamic configurability of a virtualized network environment. Consequently, the databases provided with different OSS components (based on the different hierarchical layers to which they are mapped) may need to be dynamically reconfigured as the underlying topologies change.

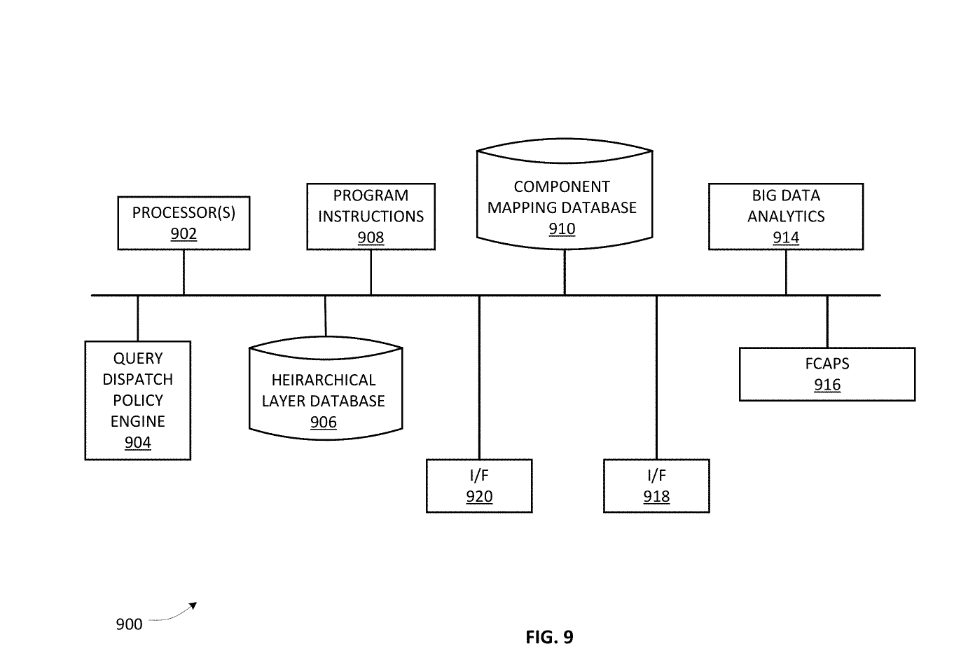

Turning to FIG. 9, depicted therein is a block diagram of a computer-implemented apparatus 900 that may be (re)configured and/or (re)arranged as a platform, server, node or element to effectuate an example OSS orchestrator or an OSS component mapped to a specific hierarchical information layer, or a combination thereof, for managing a multi-operator, multi-domain heterogeneous network environment according to an embodiment of the present patent disclosure. It should be appreciated that apparatus 900 may be implemented as a distributed data center platform in some arrangements. One or more processors 902 may be operatively coupled to various modules that may be implemented in persistent memory for executing suitable program instructions or code portions with respect to effectuating various aspects of query dispatch management, policy configuration, component⇔hierarchical information layer mapping, etc. as exemplified by modules 904, 908, 910. A level-specific database 906, i.e., specific to the hierarchical information layer, may be provided for storing appropriate domain, sub-domain, nodal level information, and so on, based on the granularity of information required in an example OSS component. Depending on the implementation, appropriate “upstream” interfaces (I/F) 918 and/or “downstream” I/Fs 920 may be provided for interfacing with external nodes (e.g., BSS nodes or customer management nodes), layer-specific network elements, and/or other OSS components, etc. Accordingly, depending on the context, interfaces selected from interfaces 918, 920 may sometimes be referred to as a first interface, a second interface, NBI or SBI, and so on. In addition, one or more FCAPS modules 916 may be provided for effectuating, under control of processors 902 and suitable program instructions 908, various FCAPS-related operations specific to the network nodes disposed at different levels of the heterogeneous hierarchical network environment. In a further arrangement, a Big Data analytics module 914 may be operative in conjunction with an OSS platform or component where enormous amounts of subscriber data, customer/tenant data, network domain and sub-network state information may need to be curated, manipulated, and analyzed for facilitating OSS operations in a multi-domain heterogeneous network environment.

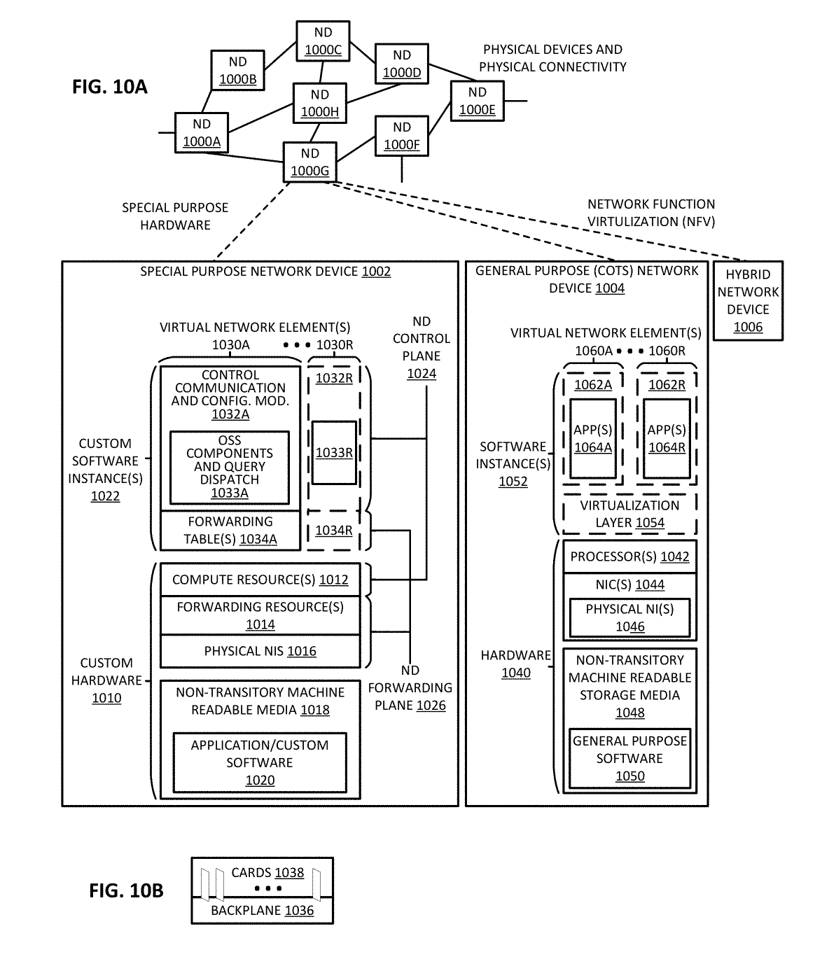

FIGS. 10A/10B illustrate connectivity between network devices (NDs) within an exemplary network, as well as three exemplary implementations of the NDs, according to some embodiments of the invention wherein at least a portion of a heterogeneous hierarchical network environment and/or associated OSS nodes/components shown in some of the Figures previously discussed may be implemented in a virtualized environment. In particular, FIG. 10A shows NDs 1000A-H, which may be representative of various servers, database nodes, OSS components, external storage nodes, as well as other network elements of a network environment, and the like, wherein example connectivity is illustrated by way of lines between A-B, B-C, C-D, D-E, E-F, F-G, and A-G, as well as between H and each of A, C, D, and G. As noted elsewhere in the patent application, such NDs may be provided as physical devices, and the connectivity between these NDs can be wireless or wired (often referred to as a link). An additional line extending from NDs 1000A, E, and F illustrates that these NDs may act as ingress and egress nodes for the network (and thus, these NDs are sometimes referred to as edge NDs; while the other NDs may be called core NDs).

Two of the exemplary ND implementations in FIG. 10A are: (1) a special-purpose network device 1002 that uses custom application-specific integrated-circuits (ASICs) and a proprietary operating system (OS); and (2) a general purpose network device 1004 that uses common off-the-shelf (COTS) processors and a standard OS.

The special-purpose network device 1002 includes appropriate hardware 1010 (e.g., custom or application-specific hardware) comprising compute resource(s) 1012 (which typically include a set of one or more processors), forwarding resource(s) 1014 (which typically include one or more ASICs and/or network processors), and physical network interfaces (NIs) 1016 (sometimes called physical ports), as well as non-transitory machine readable storage media 1018 having stored therein suitable application-specific software or program instructions 1020 (e.g., switching, routing, call processing, etc). A physical NI is a piece of hardware in an ND through which a network connection (e.g., wirelessly through a wireless network interface controller (WNIC) or through plugging in a cable to a physical port connected to a network interface controller (NIC)) is made, such as those shown by the connectivity between NDs 1000A-H. During operation, the application software 1020 may be executed by the hardware 1010 to instantiate a set of one or more application-specific or custom software instance(s) 1022. Each of the custom software instance(s) 1022, and that part of the hardware 1010 that executes that application software instance (be it hardware dedicated to that application software instance and/or time slices of hardware temporally shared by that application software instance with others of the application software instance(s) 1022), form a separate virtual network element 1030A-R. Each of the virtual network element(s) (VNEs) 1030A-R includes a control communication and configuration module 1032A-R (sometimes referred to as a local control module or control communication module) and forwarding table(s) 1034A-R with respect to suitable application/service instances 1033A-R, such that a given virtual network element (e.g., 1030A) includes the control communication and configuration module (e.g., 1032A), a set of one or more forwarding table(s) (e.g., 1034A), and that portion of the application hardware 1010 that executes the virtual network element (e.g., 1030A) for supporting one or more suitable application instances 1033A, e.g., OSS component functionalities (i.e., orchestration, NMs, EMS, etc.), query dispatching logic, and the like.

In an example implementation, the special-purpose network device 1002 is often physically and/or logically considered to include: (1) a ND control plane 1024 (sometimes referred to as a control plane) comprising the compute resource(s) 1012 that execute the control communication and configuration module(s) 1032A-R; and (2) a ND forwarding plane 1026 (sometimes referred to as a forwarding plane, a data plane, or a bearer plane) comprising the forwarding resource(s) 1014 that utilize the forwarding or destination table(s) 1034A-R and the physical NIs 1016. By way of example, where the ND is a virtual OSS node, the ND control plane 1024 (the compute resource(s) 1012 executing the control communication and configuration module(s) 1032A-R) is typically responsible for participating in controlling how bearer traffic (e.g., voice/data/video) is to be routed. Likewise, ND forwarding plane 1026 is responsible for receiving that data on the physical NIs 1016 (e.g., similar to I/Fs 918 and 920 in FIG. 9) and forwarding that data out the appropriate ones of the physical NIs 1016 based on the forwarding information.

FIG. 10B illustrates an exemplary way to implement the special-purpose network device 1002 according to some embodiments of the invention, wherein an example special-purpose network device includes one or more cards 1038 (typically hot pluggable) coupled to an interconnect mechanism. While in some embodiments the cards 1038 are of two types (one or more that operate as the ND forwarding plane 1026 (sometimes called line cards), and one or more that operate to implement the ND control plane 1024 (sometimes called control cards)), alternative embodiments may combine functionality onto a single card and/or include additional card types (e.g., one additional type of card is called a service card, resource card, or multi-application card). A service card can provide specialized processing (e.g., Layer 4 to Layer 7 services (e.g., firewall, Internet Protocol Security (IPsec) (RFC 4301 and 4309), Secure Sockets Layer (SSL)/Transport Layer Security (TLS), Intrusion Detection System (IDS), peer-to-peer (P2P), Voice over IP (VoIP) Session Border Controller, Mobile Wireless Gateways (Gateway General Packet Radio Service (GPRS) Support Node (GGSN), Evolved Packet Core (EPC) Gateway), etc.). By way of example, a service card may be used to terminate IPsec tunnels and execute the attendant authentication and encryption algorithms. These cards may be coupled together through one or more interconnect mechanisms illustrated as backplane 1036 (e.g., a first full mesh coupling the line cards and a second full mesh coupling all of the cards).

Returning to FIG. 10A, an example embodiment of the general purpose network device 1004 includes hardware 1040 comprising a set of one or more processor(s) 1042 (which are often COTS processors) and network interface controller(s) 1044 (NICs; also known as network interface cards) (which include physical NIs 1046), as well as non-transitory machine readable storage media 1048 having stored therein software 1050, e.g., general purpose operating system software, similar to the embodiments set forth above in reference to FIG. 9 in one example. During operation, the processor(s) 1042 execute the software 1050 to instantiate one or more sets of one or more applications 1064A-R with respect to facilitating converged OSS functionalities. While one embodiment does not implement virtualization, alternative embodiments may use different forms of virtualization—represented by a virtualization layer 1054 and software containers 1062A-R. For example, one such alternative embodiment implements operating system-level virtualization, in which case the virtualization layer 1054 represents the kernel of an operating system (or a shim executing on a base operating system) that allows for the creation of multiple software containers 1062A-R that may each be used to execute one of the sets of applications 1064A-R. In this embodiment, the multiple software containers 1062A-R (also called virtualization engines, virtual private servers, or jails) are each a user space instance (typically a virtual memory space); these user space instances are separate from each other and separate from the kernel space in which the operating system is run; the set of applications running in a given user space, unless explicitly allowed, cannot access the memory of the other processes. Another such alternative embodiment implements full virtualization, in which case: (1) the virtualization layer 1054 represents a hypervisor (sometimes referred to as a virtual machine monitor (VMM) as noted elsewhere in the present patent application) or a hypervisor executing on top of a host operating system; and (2) the software containers 1062A-R each represent a tightly isolated form of software container called a virtual machine that is run by the hypervisor and may include a guest operating system. A virtual machine is a software implementation of a physical machine that runs programs as if they were executing on a physical, non-virtualized machine; and applications generally do not know they are running on a virtual machine as opposed to running on a “bare metal” host electronic device, though some systems provide para-virtualization which allows an operating system or application to be aware of the presence of virtualization for optimization purposes.

The instantiation of the one or more sets of one or more applications 1064A-R, as well as the virtualization layer 1054 and software containers 1062A-R if implemented, are collectively referred to as software instance(s) 1052. Each set of applications 1064A-R, corresponding software container 1062A-R if implemented, and that part of the hardware 1040 that executes them (be it hardware dedicated to that execution and/or time slices of hardware temporally shared by software containers 1062A-R), forms a separate virtual network element(s) 1060A-R.

The virtual network element(s) 1060A-R perform similar functionality to the virtual network element(s) 1030A-R—e.g., similar to the control communication and configuration module(s) 1032A and forwarding table(s) 1034A (this virtualization of the hardware 1040 is sometimes referred to as Network Function Virtualization (NFV) architecture, as mentioned elsewhere in the present patent application. Thus, NFV may be used to consolidate many network equipment types onto industry standard high volume server hardware, physical switches, and physical storage, which could be located in data centers, NDs, and customer premise equipment (CPE). However, different embodiments of the invention may implement one or more of the software container(s) 1062A-R differently. For example, while embodiments of the invention may be practiced in an arrangement wherein each software container 1062A-R corresponds to one VNE 1060A-R, alternative embodiments may implement this correspondence at a finer level granularity (e.g., line card virtual machines virtualize line cards, control card virtual machine virtualize control cards, etc.); it should be understood that the techniques described herein with reference to a correspondence of software containers 1062A-R to VNEs also apply to embodiments where such a finer level of granularity is used.

In certain embodiments, the virtualization layer 1054 includes a virtual switch that provides similar forwarding services as a physical Ethernet switch. Specifically, this virtual switch forwards traffic between software containers 1062A-R and the NIC(s) 1044, as well as optionally between the software containers 1062A-R. In addition, this virtual switch may enforce network isolation between the VNEs 1060A-R that by policy are not permitted to communicate with each other (e.g., by honoring virtual local area networks (VLANs)).

The third exemplary ND implementation in FIG. 10A is a hybrid network device 1006, which may include both custom ASICs/proprietary OS and COTS processors/standard OS in a single ND or a single card within an ND. In certain embodiments of such a hybrid network device, a platform VM (i.e., a VM that implements the functionality of the special-purpose network device 1002) could provide for para-virtualization to the application-specific hardware present in the hybrid network device 1006 for effectuating one or more components, blocks, modules, and functionalities of a converged OSS platform.

Regardless of the above exemplary implementations of an ND, when a single one of multiple VNEs implemented by an ND is being considered (e.g., only one of the VNEs is part of a given virtual network) or where only a single VNE is currently being implemented by an ND, the shortened term network element (NE) is sometimes used to refer to that VNE. Also in all of the above exemplary implementations, each of the VNEs (e.g., VNE(s) 1030A-R, VNEs 1060A-R, and those in the hybrid network device 1006) receives data on the physical NIs (e.g., 1016, 1046) and forwards that data out the appropriate ones of the physical NIs (e.g., 1016, 1046).

Accordingly, various hardware and software blocks configured for effectuating an example converged OSS including policy-based query dispatching functionality may be embodied in NDs, NEs, NFs, VNE/VNF/VND, virtual appliances, virtual machines, and the like, as well as electronic devices and machine-readable media, which may be configured as any of the apparatuses described herein. One skilled in the art will therefore recognize that various apparatuses and systems with respect to the foregoing embodiments, as well as the underlying network infrastructures set forth above may be architected in a virtualized environment according to a suitable NFV architecture in additional or alternative embodiments of the present patent disclosure as noted above in reference to FIG. 8. Accordingly, for purposes of at least one embodiment of the present invention, the following detailed description may be additionally and/or alternatively provided, mutatis mutandis, in an example implementation with respect to the OSS components and/or the associated network elements of a hierarchical network environment.

An electronic device stores and transmits (internally and/or with other electronic devices over a network) code (which is composed of software instructions and which is sometimes referred to as computer program code or a computer program) and/or data using machine-readable media (also called computer-readable media), such as machine-readable storage media (e.g., magnetic disks, optical disks, solid state drives, read only memory (ROM), flash memory devices, phase change memory) and machine-readable transmission media (also called a carrier) (e.g., electrical, optical, radio, acoustical or other form of propagated signals—such as carrier waves, infrared signals). Thus, an electronic device (e.g., a computer) includes hardware and software, such as a set of one or more processors (e.g., wherein a processor is a microprocessor, controller, microcontroller, central processing unit, digital signal processor, application specific integrated circuit, field programmable gate array, other electronic circuitry, a combination of one or more of the preceding) coupled to one or more machine-readable storage media to store code for execution on the set of processors and/or to store data. For instance, an electronic device may include non-volatile memory containing the code since the non-volatile memory can persist code/data even when the electronic device is turned off (when power is removed), and while the electronic device is turned on that part of the code that is to be executed by the processor(s) of that electronic device is typically copied from the slower non-volatile memory into volatile memory (e.g., dynamic random access memory (DRAM), static random access memory (SRAM)) of that electronic device. Typical electronic devices also include a set or one or more physical network interface(s) (NI(s)) to establish network connections (to transmit and/or receive code and/or data using propagating signals) with other electronic devices. For example, the set of physical NIs (or the set of physical NI(s) in combination with the set of processors executing code) may perform any formatting, coding, or translating to allow the electronic device to send and receive data whether over a wired and/or a wireless connection. In some embodiments, a physical NI may comprise radio circuitry capable of receiving data from other electronic devices over a wireless connection or channel and/or sending data out to other devices via a wireless connection or channel. This radio circuitry may include transmitter(s), receiver(s), and/or transceiver(s) suitable for radiofrequency communication. The radio circuitry may convert digital data into a radio signal having the appropriate parameters (e.g., frequency, timing, channel, bandwidth, etc.). The radio signal may then be transmitted via antennas to the appropriate recipient(s).

In some embodiments, the set of physical NI(s) may comprise network interface controller(s) (NICs), also known as a network interface card, network adapter, or local area network (LAN) adapter. The NIC(s) may facilitate in connecting the electronic device to other electronic devices allowing them to communicate via wire through plugging in a cable to a physical port connected to a NIC. One or more parts of an embodiment of the invention may be implemented using different combinations of software, firmware, and/or hardware.

A network device (ND) or network element (NE) as set hereinabove is an electronic device that communicatively interconnects other electronic devices on the network (e.g., other network devices, end-user devices, etc.). Some network devices are “multiple services network devices” that provide support for multiple networking functions (e.g., routing, bridging, switching, Layer 2 aggregation, session border control, Quality of Service, and/or subscriber management), and/or provide support for multiple application services (e.g., data, voice, and video). The apparatus, and method performed thereby, of the present invention may be embodied in one or more ND/NE nodes that may be, in some embodiments, communicatively connected to other electronic devices on the network (e.g., other network devices, servers, nodes, terminals, etc.). The example NE/ND node may comprise processor resources, memory resources, and at least one interface. These components may work together to provide various OSS functionalities as disclosed herein.

Memory may store code (which is composed of software instructions and which is sometimes referred to as computer program code or a computer program) and/or data using non-transitory machine-readable (e.g., computer-readable) media, such as machine-readable storage media (e.g., magnetic disks, optical disks, solid state drives, ROM, flash memory devices, phase change memory) and machine-readable transmission media (e.g., electrical, optical, radio, acoustical or other form of propagated signals—such as carrier waves, infrared signals). For instance, memory may comprise non-volatile memory containing code to be executed by processor. Where memory is non-volatile, the code and/or data stored therein can persist even when the network device is turned off (when power is removed). In some instances, while network device is turned on that part of the code that is to be executed by the processor(s) may be copied from non-volatile memory into volatile memory of network device.

The at least one interface may be used in the wired and/or wireless communication of signaling and/or data to or from network device. For example, interface may perform any formatting, coding, or translating to allow network device to send and receive data whether over a wired and/or a wireless connection. In some embodiments, interface may comprise radio circuitry capable of receiving data from other devices in the network over a wireless connection and/or sending data out to other devices via a wireless connection. In some embodiments, interface may comprise network interface controller(s) (NICs), also known as a network interface card, network adapter, local area network (LAN) adapter or physical network interface. The NIC(s) may facilitate in connecting the network device to other devices allowing them to communicate via wire through plugging in a cable to a physical port connected to a NIC. As explained above, in particular embodiments, the processor may represent part of interface, and some or all of the functionality described as being provided by interface may be provided more specifically by processor.

The components of network device are each depicted as separate boxes located within a single larger box for reasons of simplicity in describing certain aspects and features of network device disclosed herein. In practice however, one or more of the components illustrated in the example network device may comprise multiple different physical elements

One or more embodiments described herein may be implemented in the network device by means of a computer program comprising instructions which, when executed on at least one processor, cause the at least one processor to carry out the actions according to any of the invention's features and embodiments, where appropriate. While the modules are illustrated as being implemented in software stored in memory, other embodiments implement part or all of each of these modules in hardware.

In one embodiment, the software implements the modules described with regard to the Figures herein. During operation, the software may be executed by the hardware to instantiate a set of one or more software instance(s). Each of the software instance(s), and that part of the hardware that executes that software instance (be it hardware dedicated to that software instance, hardware in which a portion of available physical resources (e.g., a processor core) is used, and/or time slices of hardware temporally shared by that software instance with others of the software instance(s)), form a separate virtual network element. Thus, in the case where there are multiple virtual network elements, each operates as one of the network devices.

Some of the described embodiments may also be used where various levels or degrees of virtualization has been implemented. In certain embodiments, one, some or all of the applications relating to a converged OSS architecture may be implemented as unikernel(s), which can be generated by compiling directly with an application only a limited set of libraries (e.g., from a library operating system (LibOS) including drivers/libraries of OS services) that provide the particular OS services needed by the application. As a unikernel can be implemented to run directly on hardware directly on a hypervisor (in which case the unikernel is sometimes described as running within a LibOS virtual machine), or in a software container, embodiments can be implemented fully with unikernels running directly on a hypervisor represented by virtualization layer, unikernels running within software containers represented by instances, or as a combination of unikernels and the above-described techniques (e.g., unikernels and virtual machines both run directly on a hypervisor, unikernels and sets of applications that are run in different software containers).

The instantiation of the one or more sets of one or more applications, as well as virtualization if implemented are collectively referred to as software instance(s). Each set of applications, corresponding virtualization construct if implemented, and that part of the hardware that executes them (be it hardware dedicated to that execution and/or time slices of hardware temporally shared by software containers), forms a separate virtual network element(s).

A virtual network is a logical abstraction of a physical network that provides network services (e.g., L2 and/or L3 services). A virtual network can be implemented as an overlay network (sometimes referred to as a network virtualization overlay) that provides network services (e.g., Layer 2 (L2, data link layer) and/or Layer 3 (L3, network layer) services) over an underlay network (e.g., an L3 network, such as an Internet Protocol (IP) network that uses tunnels (e.g., generic routing encapsulation (GRE), Layer 2 tunneling protocol (L2TP), IPSec) to create the overlay network).

A network virtualization edge (NVE) sits at the edge of the underlay network and participates in implementing the network virtualization; the network-facing side of the NVE uses the underlay network to tunnel frames to and from other NVEs; the outward-facing side of the NVE sends and receives data to and from systems outside the network. A virtual network instance (VNI) is a specific instance of a virtual network on a NVE (e.g., a NE/VNE on an ND, a part of a NE/VNE on a ND where that NE/VNE is divided into multiple VNEs through emulation); one or more VNIs can be instantiated on an NVE (e.g., as different VNEs on an ND). A virtual access point (VAP) is a logical connection point on the NVE for connecting external systems to a virtual network; a VAP can be physical or virtual ports identified through logical interface identifiers (e.g., a VLAN ID).

Examples of network services also include: 1) an Ethernet LAN emulation service (an Ethernet-based multipoint service similar to an Internet Engineering Task Force (IETF) Multiprotocol Label Switching (MPLS) or Ethernet VPN (EVPN) service) in which external systems are interconnected across the network by a LAN environment over the underlay network (e.g., an NVE provides separate L2 VNIs (virtual switching instances) for different such virtual networks, and L3 (e.g., IP/MPLS) tunneling encapsulation across the underlay network); and 2) a virtualized IP forwarding service (similar to IETF IP VPN (e.g., Border Gateway Protocol (BGP)/MPLS IPVPN) from a service definition perspective) in which external systems are interconnected across the network by an L3 environment over the underlay network (e.g., an NVE provides separate L3 VNIs (forwarding and routing instances) for different such virtual networks, and L3 (e.g., IP/MPLS) tunneling encapsulation across the underlay network)). Example network services that may be hosted by a data center may also include quality of service capabilities (e.g., traffic classification marking, traffic conditioning and scheduling), security capabilities (e.g., filters to protect customer premises from network—originated attacks, to avoid malformed route announcements), and management capabilities (e.g., full detection and processing).

Embodiments of a converged OSS architecture and/or associated heterogeneous multi-domain networks may involve distributed routing, centralized routing, or a combination thereof. The distributed approach distributes responsibility for generating the reachability and forwarding information across the NEs; in other words, the process of neighbor discovery and topology discovery is distributed. For example, where the network device is a traditional router, the control communication and configuration module(s) of the ND control plane typically include a reachability and forwarding information module to implement one or more routing protocols (e.g., an exterior gateway protocol such as Border Gateway Protocol (BGP), Interior Gateway Protocol(s) (IGP) (e.g., Open Shortest Path First (OSPF), Intermediate System to Intermediate System (IS-IS), Routing Information Protocol (RIP), Label Distribution Protocol (LDP), Resource Reservation Protocol (RSVP) (including RSVP-Traffic Engineering (TE): Extensions to RSVP for LSP Tunnels and Generalized Multi-Protocol Label Switching (GMPLS) Signaling RSVP-TE)) that communicate with other NEs to exchange routes, and then selects those routes based on one or more routing metrics. Thus, the NEs perform their responsibility for participating in controlling how data (e.g., packets) is to be routed (e.g., the next hop for the data and the outgoing physical NI for that data) by distributively determining the reachability within the network and calculating their respective forwarding information. Routes and adjacencies are stored in one or more routing structures (e.g., Routing Information Base (RIB), Label Information Base (LIB), one or more adjacency structures) on the ND control plane. The ND control plane programs the ND forwarding plane with information (e.g., adjacency and route information) based on the routing structure(s). For example, the ND control plane programs the adjacency and route information into one or more forwarding table(s) (e.g., Forwarding Information Base (FIB), Label Forwarding Information Base (LFIB), and one or more adjacency structures) on the ND forwarding plane. For Layer 2 forwarding, the ND can store one or more bridging tables that are used to forward data based on the Layer 2 information in that data. While the above example uses the special-purpose network device, the same distributed approach can be implemented on a general purpose network device and a hybrid network device, e.g., as exemplified in the embodiments of FIGS. 10A/10B described above.

Skilled artisans will further recognize that an example OSS architecture may also be implemented using various SDN architectures based on known protocols such as, e.g., OpenFlow protocol or Forwarding and Control Element Separation (ForCES) protocol, etc. Regardless of whether distributed or centralized networking is implemented with respect to a particular network environment, some NDs may be configured to include functionality for authentication, authorization, and accounting (AAA) protocols (e.g., RADIUS (Remote Authentication Dial-In User Service), Diameter, and/or TACACS+(Terminal Access Controller Access Control System Plus), which may interoperate with the converged OSS orchestrator functionality via suitable protocols. AAA can be provided through a client/server model, where the AAA client is implemented on a ND and the AAA server can be implemented either locally on the ND or on a remote electronic device coupled with the ND. Authentication is the process of identifying and verifying a subscriber. For instance, a subscriber/tenant/customer might be identified by a combination of a username and a password or through a unique key. Authorization determines what a subscriber can do after being authenticated, such as gaining access to certain electronic device information resources (e.g., through the use of access control policies). Accounting is recording user activity. By way of a summary example, end user devices may be coupled (e.g., through an access network) through an edge ND (supporting AAA processing) coupled to core NDs coupled to electronic devices implementing servers of service/content providers. AAA processing is performed to identify for a subscriber the subscriber record stored in the AAA server for that subscriber. A subscriber record includes a set of attributes (e.g., subscriber name, password, authentication information, access control information, rate-limiting information, policing information) used during processing of that subscriber's traffic.

Certain NDs (e.g., certain edge NDs) internally represent end user devices (or sometimes customer premise equipment (CPE) such as a residential gateway (e.g., a router, modem)) using subscriber circuits. A subscriber circuit uniquely identifies within the ND a subscriber session and typically exists for the lifetime of the session. Thus, a ND typically allocates a subscriber circuit when the subscriber connects to that ND, and correspondingly de-allocates that subscriber circuit when that subscriber disconnects. Each subscriber session represents a distinguishable flow of packets communicated between the ND and an end user device (or sometimes CPE such as a residential gateway or modem) using a protocol, such as the point-to-point protocol over another protocol (PPPoX) (e.g., where X is Ethernet or Asynchronous Transfer Mode (ATM)), Ethernet, 802.1Q Virtual LAN (VLAN), Internet Protocol, or ATM). A subscriber session can be initiated using a variety of mechanisms (e.g., manual provisioning a dynamic host configuration protocol (DHCP), DHCP/client-less internet protocol service (CLIPS) or Media Access Control (MAC) address tracking). For example, the point-to-point protocol (PPP) is commonly used for digital subscriber line (DSL) services and requires installation of a PPP client that enables the subscriber to enter a username and a password, which in turn may be used to select a subscriber record. When DHCP is used (e.g., for cable modem services), a username typically is not provided; but in such situations other information (e.g., information that includes the MAC address of the hardware in the end user device (or CPE)) is provided. The use of DHCP and CLIPS on the ND captures the MAC addresses and uses these addresses to distinguish subscribers and access their subscriber records.

Furthermore, skilled artisans will also appreciate that where an example OSS platform is implemented in association with cloud-computing environment, it may comprise one or more of private clouds, public clouds, hybrid clouds, community clouds, distributed clouds, multiclouds and interclouds (e.g., “cloud of clouds”), and the like.

Based on the foregoing Detailed Description, skilled artisans will appreciate that embodiments of the present invention advantageously overcome several deficiencies and shortcomings of the state of the art, including but not limited to the following. Existing OSS arrangements require inefficient replication of vast amounts of data relating to an underlying network environment since different infrastructure components and services require different level of detail for the same resources. For example, different OSS components are needed in a conventional solution for facilitating VPN provisioning and alarm correlation at the same time. Also, providing each of the different components with a direct access to southbound interfaces (SBI) requires replicated functionality to interpret and process the data, as well as requiring the storage and coordinating the refresh of duplicated information in multiple components. As different components not only require different levels of information from the network environment but also have different requirements on how frequently the information is updated or refreshed, conventional OSS arrangements cannot provide a more modulated treatment with respect to different types of queries. For instance, in the case of service provisioning the application only needs to know if a service has degraded Key Performance Indicators (KPIs) or if a node is added or removed from the network (e.g., with a delay in the order of seconds if not tens of seconds), while the alarm correlation or processing monitoring needs to be performed in real-time (e.g., with a delay in the order of sub-seconds or milliseconds). Query treatment modulation by an OSS based on such information granularity may be advantageously provided in accordance with example embodiments set forth herein.

In the above-description of various embodiments of the present disclosure, it is to be understood that the terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of this specification and the relevant art and may not be interpreted in an idealized or overly formal sense expressly so defined herein.

At least some example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. Such computer program instructions may be provided to a processor circuit of a general purpose computer circuit, special purpose computer circuit, and/or other programmable data processing circuit to produce a machine, so that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s). Additionally, the computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks.

As pointed out previously, tangible, non-transitory computer-readable medium may include an electronic, magnetic, optical, electromagnetic, or semiconductor data storage system, apparatus, or device. More specific examples of the computer-readable medium would include the following: a portable computer diskette, a random access memory (RAM) circuit, a ROM circuit, an erasable programmable read-only memory (EPROM or Flash memory) circuit, a portable compact disc read-only memory (CD-ROM), and a portable digital video disc read-only memory (DVD/Blu-ray). The computer program instructions may also be loaded onto or otherwise downloaded to a computer and/or other programmable data processing apparatus to cause a series of operational steps to be performed on the computer and/or other programmable apparatus to produce a computer-implemented process. Accordingly, embodiments of the present invention may be embodied in hardware and/or in software (including firmware, resident software, micro-code, etc.) that runs on a processor or controller, which may collectively be referred to as “circuitry,” “a module” or variants thereof. Further, an example processing unit may include, by way of illustration, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGA) circuits, any other type of integrated circuit (IC), and/or a state machine. As can be appreciated, an example processor unit may employ distributed processing in certain embodiments.

Further, in at least some additional or alternative implementations, the functions/acts described in the blocks may occur out of the order shown in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Furthermore, although some of the diagrams include arrows on communication paths to show a primary direction of communication, it is to be understood that communication may occur in the opposite direction relative to the depicted arrows. Finally, other blocks may be added/inserted between the blocks that are illustrated.

It should therefore be clearly understood that the order or sequence of the acts, steps, functions, components or blocks illustrated in any of the flowcharts depicted in the drawing Figures of the present disclosure may be modified, altered, replaced, customized or otherwise rearranged within a particular flowchart, including deletion or omission of a particular act, step, function, component or block. Moreover, the acts, steps, functions, components or blocks illustrated in a particular flowchart may be inter-mixed or otherwise inter-arranged or rearranged with the acts, steps, functions, components or blocks illustrated in another flowchart in order to effectuate additional variations, modifications and configurations with respect to one or more processes for purposes of practicing the teachings of the present patent disclosure.

Although various embodiments have been shown and described in detail, the claims are not limited to any particular embodiment or example. None of the above Detailed Description should be read as implying that any particular component, element, step, act, or function is essential such that it must be included in the scope of the claims. Reference to an element in the singular is not intended to mean “one and only one” unless explicitly so stated, but rather “one or more.” All structural and functional equivalents to the elements of the above-described embodiments that are known to those of ordinary skill in the art are expressly incorporated herein by reference and are intended to be encompassed by the present claims. Accordingly, those skilled in the art will recognize that the exemplary embodiments described herein can be practiced with various modifications and alterations within the spirit and scope of the claims appended below.

1. An Operations Support System (OSS) for managing a hierarchical network environment including a plurality of network domains, the OSS comprising:
one or more processors;
a northbound interface configured to receive queries from one or more external requesters;
a plurality of OSS components each configured to manage a particular level of the hierarchical network environment, each particular level requiring a corresponding hierarchical information layer having a set of associated characteristics; and
a query dispatcher module coupled to the one or more processors and having program instructions that are configured to perform following acts when executed by the one or more processors:
mapping each OSS component against a particular hierarchical information layer;
when a query is received at the northbound interface from an external requester, determining which particular hierarchical information layers are required to generate a response to the query;
responsive to the determination, forwarding the query to one or more OSS components mapped to the particular hierarchical information layers; and
generating a response to the external requester based on information received from the one or more OSS components responsive to the query.

2. The OSS as recited in claim 1, wherein the query dispatcher module further comprises program instructions configured to determine that the query contains an explicit indication operative to indicate the particular hierarchical information layers required to generate the response.

3. The OSS as recited in claim 1, wherein the query dispatcher module further comprises program instructions configured to determine that the query is to be forwarded implicitly based on the query's type to the particular hierarchical information layers required to generate the response.

4. The OSS as recited in claim 1, wherein an OSS component is an orchestrator mapped against a service information layer relating to policies involving two or more network domains.

5. The OSS as recited in claim 4, wherein the query dispatcher is integrated with the orchestrator.

6. The OSS as recited in claim 1, wherein an OSS component is a network manager mapped against an intra-domain information layer relating to policies involving a single network domain.

7. The OSS as recited in claim 1, wherein an OSS component is an element manager mapped against a node information layer relating to policies involving a single network element of a particular network domain.

8. A method operating at an Operations Support System (OSS) for managing a hierarchical network environment including a plurality of network domains, the method comprising:
mapping each OSS component of the OSS against a particular hierarchical information layer of a plurality of hierarchical information layers required to manage the hierarchical network environment, each hierarchical information layer having a set of associated characteristics;
receiving a query at a northbound interface of the OSS from an external requester;
determining which particular hierarchical information layers are required to generate a response to the query;
responsive to the determination, forwarding the query to one or more OSS components mapped to the particular hierarchical information layers; and
generating a response to the external requester based on information received from the one or more OSS components.

9. The method as recited in claim 8, further comprising:
determining that the query contains an explicit indication operative to indicate the particular hierarchical information layers required to generate the response.

10. The method as recited in claim 8, further comprising:
determining that the query is to be forwarded implicitly based on the query's type to the particular hierarchical information layers required to generate the response.

11. The method as recited in claim 8, further comprising:
mapping an OSS component as an orchestrator associated with a service information layer relating to policies involving two or more network domains.

12. The method as recited in claim 8, further comprising:
mapping an OSS component as a network manager associated with an intra-domain information layer relating to policies involving a single network domain.

13. The method as recited in claim 8, further comprising:
mapping an OSS component as an element manager associated with a node information layer relating to policies involving a single network element of a particular network domain.

14. A non-transitory machine-readable storage medium having program instructions thereon, which are configured to perform following acts when executed by one or more processors associated with an Operations Support System (OSS) for managing a hierarchical network environment including a plurality of network domains:
mapping each OSS component of the OSS against a particular hierarchical information layer of a plurality of hierarchical information layers required to manage the hierarchical network environment, each hierarchical information layer having a set of associated characteristics;
receiving a query at a northbound interface of the OSS from an external requester;
determining which particular hierarchical information layers are required to generate a response to the query;
responsive to the determination, forwarding the query to one or more OSS components mapped to the particular hierarchical information layers; and
generating a response to the external requester based on information received from the one or more OSS components.

15. The non-transitory machine-readable storage medium as recited in claim 14, further comprising program instructions configured to determine that the query contains an explicit indication operative to indicate the particular hierarchical information layers required to generate the response.

16. The non-transitory machine-readable storage medium as recited in claim 14, further comprising program instructions configured to determine that the query is to be forwarded implicitly based on the query's type to the particular hierarchical information layers required to generate the response.

17. The non-transitory machine-readable storage medium as recited in claim 14, further comprising program instructions configured to map an OSS component as an orchestrator associated with a service information layer relating to policies involving two or more network domains.

18. The non-transitory machine-readable storage medium as recited in claim 14, further comprising program instructions configured to map an OSS component as a network manager associated with an intra-domain information layer relating to policies involving a single network domain.

19. The non-transitory machine-readable storage medium as recited in claim 14, further comprising program instructions configured to map an OSS component as an element manager associated with a node information layer relating to policies involving a single network element of a particular network domain.
